(19) United States
(12) Patent Application Publication
(10) Pub. No.: US 2026/0334660 A1
(43) Pub. Date: Oct. 29, 2026

(54) WORK EQUIPMENT HOLDER

(71) Applicant: TJM DESIGN CORPORATION, Itabashi-ku, Tokyo (JP)

(72) Inventors: Akio GOTO, Itabashi-ku, Tokyo (JP); Kenta KAWANISHI, Itabashi-ku, Tokyo (JP)

(73) Assignee: TJM DESIGN CORPORATION, Itabashi-ku, Tokyo (JP)

(21) Appl. No.: 19/486,519

(22) PCT Filed: May 20, 2024
(86) PCT No.: PCT/JP2024/018563

§ 371 Date: Nov. 21, 2025

(30) Foreign Application Priority Data
May 30, 2023 (JP) 2023-089057

(51) Int. Cl. A45F 5/02; A45F 5/00

(52) U.S. Cl. CPC A45F 5/021; A45F 5/1575

(57) ABSTRACT

A holder (1A) comprises: a holding portion (2) that holds equipment; a plate portion (3) disposed on a rear side of the portion (2); a pin (4) connecting the portion (2) and the portion (3); and an elastic member (6) attached to the pin (4). The member (6) biases a pressing portion (32) of the portion (3) in a direction approaching the portion (2) with the pin (4). A long hole (5) through which the pin (4) slidably passes is formed in the portion (2). The portion (2) is provided with a swing restriction portion (7) that restricts swinging of the portion (3) in a state in which the portion (3) is moved along the hole (5) to a pressing portion side, and allows swinging of the portion (3) in a state in which the portion (3) is moved along the hole (5) to an operation portion side.

### DESCRIPTION

### Technical Field

The present disclosure relates to a work equipment holder. The present application claims priority to and the benefit of Japanese Patent Application No. 2023-89057 filed May 30, 2023, the entire contents of which are incorporated herein by reference.

### Background

A conventional work equipment holder includes a belt insertion portion (opening) that is formed on the rear side of a holding portion for holding work equipment and through which a wearer's belt is passed (see, for example, PTL 1). The work equipment holder described in PTL 1 cannot be attached or detached while the belt is worn on the body (hereinafter also simply referred to as “later attachment”). Thus, with the work equipment holder described in PTL 1, it is necessary to remove the equipment (work equipment) attached to the work belt and then pass the work belt through the belt insertion portion to attach the holder.

Another conventional work equipment holder includes a belt insertion portion that hangs rearward from the upper part of the rear surface of a clip body so that a belt can be inserted between the rear surface of the clip body and the belt insertion portion (see, for example, PTL 2). Although the work equipment holder described in PTL 2 can be later-attached to the belt, there is a risk that the work equipment holder may fall off the belt if, for example, the work equipment holder is pushed up from below.

Still another conventional work equipment holder includes a main body portion that holds a tool, and a movable member attached to the main body portion (see, for example, PTL 3). In the work equipment holder described in PTL 3, the main body portion includes a plate-like portion that is folded back at its upper end, an internal space that is formed between the main body portion and the plate-like portion and into which a work belt is inserted, and an opening that is provided at a lower end part of the plate-like portion and through which the work belt can be inserted into and removed from the internal space. The movable member is movable between a first position where it is positioned on a track for inserting and removing the work belt through the opening to be able to hold the work belt in the internal space and a second position where it is not positioned on the track for inserting and removing the work belt through the opening in the plate-like portion. Furthermore, at the first position, the movable member is configured to engage with the plate-like portion so as to maintain the first position. In the work equipment holder described in PTL 3, the movable member is rotated to move from the second position to the first position, and thereafter the first position can be maintained.

### CITATION LIST

### Patent Literature

PTL 1: JP 2019-196966 A
PTL 2: JP 3163381 U
PTL 3: JP 2014-104518 A

### SUMMARY

### Technical Problem

However, the work equipment holder described in PTL 3 requires operating the movable member provided separately from the main body portion and the plate-like portion in order to switch between the first position and the second position. Specifically, after the work equipment holder described in PTL 3 is later-attached to a belt, the movable member needs to be rotated relative to the lower end part of the plate-like portion to fit a protrusion formed on the movable member into a recess formed on the plate-like portion so that the plate-like portion will not open relative to the main body portion. In other words, the work equipment holder described in PTL 3 requires complicated operation to prevent the plate-like portion from opening relative to the holding portion after later attachment.

It could therefore be helpful to provide a work equipment holder that can be later-attached to a belt and can prevent, through a simple operation, a plate-like portion from opening after being later-attached to the belt.

### Solution to Problem

(1) A work equipment holder according to the present disclosure is a work equipment holder configured to attach work equipment to a belt, the work equipment holder comprising: a holding portion configured to hold the work equipment on a front side; a plate-like portion disposed on a rear side of the holding portion; a connecting pin swingably connecting the holding portion and the plate-like portion; and an elastic member attached to the connecting pin, wherein the elastic member is configured to bias an operation portion of the plate-like portion in a direction away from the holding portion, to bias a pressing portion of the plate-like portion in a direction approaching the holding portion with the connecting pin as a pivot, a long hole through which the connecting pin slidably passes is formed in the holding portion or the plate-like portion, and a swing restriction portion is provided on the rear side of the holding portion, the swing restriction portion being configured to restrict swinging of the plate-like portion in a state in which the plate-like portion is moved along the long hole to a pressing portion side of the plate-like portion, and allow swinging of the plate-like portion in a state in which the plate-like portion is moved along the long hole to an operation portion side of the plate-like portion.
(2) In the work equipment holder according to (1), it is preferable that the plate-like portion includes a stopper configured to, when the plate-like portion is moved along the long hole to the pressing portion side of the plate-like portion in a state in which the operation portion of the plate-like portion is pushed toward the holding portion, contact the holding portion before a pressing portion-side end part of the plate-like portion reaches the swing restriction portion, thereby preventing the plate-like portion from moving along the long hole to the pressing portion side of the plate-like portion.
(3) In the work equipment holder according to (1) or (2), it is preferable that a relief hole extending in a direction away from the holding portion is connected to a pressing portion-side end part of the long hole.
(4) In the work equipment holder according to any one of (1) to (3), it is preferable that the holding portion or the plate-like portion is provided with a raised portion with which the elastic member is releasably locked at at least one of a position where the plate-like portion is moved along the long hole to the pressing portion side of the plate-like portion and a position where the plate-like portion is moved along t he long hole to the operation portion side of the plate-like portion.
(5) In the work equipment holder according to any one of (1) to (4), it is preferable that the plate-like portion includes an inclined portion that inclines toward the holding portion as it approaches a pressing portion-side end part of the plate-like portion so that, when the operation portion of the plate-like portion is pushed toward the holding portion, the pressing portion of the plate-like portion will be parallel to the rear side of the holding portion.
(6) In the work equipment holder according to any one of (1) to (5), it is preferable that the torsion spring includes one folded portion, two coil portions, and two arm portions, the one folded portion biases one of the holding portion and the plate-like portion, and the two arm portions bias the other of the holding portion and the plate-like portion.
(7) In the work equipment holder according to any one of (1) to (6), it is preferable that the plate-like portion includes a groove or a protrusion formed in a push-in portion of the operation portion.
(8) In the work equipment holder according to any one of (1) to (7), it is preferable that the plate-like portion includes an operation portion-side end part extending toward the holding portion, and a depression is formed at a holding portion-side end of the operation portion-side end part.
(9) In the work equipment holder according to any one of (1) to (8), it is preferable that the plate-like portion includes a bent recess.
(10) In the work equipment holder according to any one of (1) to (9), the swing restriction portion may be an arch portion bridged across the rear side of the holding portion.
(11) In the work equipment holder according to any one of (1) to (10), the swing restriction portion may be a return portion that is bent back on the rear side of the holding portion from a pressing portion-side end part of the holding portion toward an operation portion-side end part of the holding portion.

### Advantageous Effect

It is thus possible to provide a work equipment holder that can be later-attached to a belt and can prevent, through a simple operation, a plate-like portion from opening after being later-attached to the belt.

### BRIEF DESCRIPTION OF THE DRAWINGS

In the accompanying drawings:

FIG. 1 is a front view schematically illustrating a work equipment holder according to Embodiment 1 of the present disclosure in a state in which a pressing portion-side end part of a plate-like portion is removed from an accommodation hole formed in a swing restriction portion;

FIG. 2 is a rear view schematically illustrating the work equipment holder in FIG. 1;

FIG. 3 is a left side view schematically illustrating the work equipment holder in FIG. 1;

FIG. 4 is a right side view schematically illustrating the work equipment holder in FIG. 1;

FIG. 5 is a plan view schematically illustrating the work equipment holder in FIG. 1;

FIG. 6 is a bottom view schematically illustrating the work equipment holder in FIG. 1;

FIG. 7 is a sectional view schematically illustrating the work equipment holder in FIG. 2 along line A-A, in a state in which the pressing portion-side end part of the plate-like portion is accommodated in the accommodation hole formed in the swing restriction portion as a result of the plate-like portion being moved along a long hole formed in the holding portion to its limit on the pressing portion side;

FIG. 8 is a sectional view schematically illustrating the work equipment holder in FIG. 7 along line A-A, in a state in which the pressing portion-side end part of the plate-like portion is opened after the plate-like portion is moved along the long hole formed in the holding portion to its limit on the operation portion side;

FIG. 9 is an enlarged right side view schematically illustrating the vicinity of the long hole provided in the holding portion of the work equipment holder in FIG. 3;

FIG. 10 is a perspective view schematically illustrating the work equipment holder in FIG. 7 as viewed from the pressing portion-side end part;

FIG. 11 is a perspective view schematically illustrating the work equipment holder in FIG. 8 as viewed from the pressing portion-side end part;

FIG. 12 is a perspective view schematically illustrating an exemplary torsion spring used in the work equipment holder in FIG. 7;

FIG. 13A is a front view schematically illustrating another exemplary torsion spring that can be used in a work equipment holder according to the present disclosure;

FIG. 13B is a side view schematically illustrating the torsion spring in FIG. 13A;

FIG. 14 is a perspective view schematically illustrating the relationship between the holding portion and the torsion spring in a state in which the pressing portion-side end part of the plate-like portion is accommodated in the accommodation hole of the swing restriction portion provided in the holding portion in the work equipment holder in FIG. 7;

FIG. 15 is a perspective view schematically illustrating the relationship between the plate-like portion and the torsion spring in a state in which the pressing portion-side end part of the plate-like portion is accommodated in the accommodation hole of the swing restriction portion provided in the holding portion in the work equipment holder in FIG. 7;

FIG. 16 is a perspective view schematically illustrating the relationship between the holding portion and the torsion spring in a state in which the pressing portion-side end part of the plate-like portion is withdrawn from the accommodation hole of the swing restriction portion provided in the holding portion in the work equipment holder in FIG. 7;

FIG. 17 is a perspective view schematically illustrating the relationship between the plate-like portion and the torsion spring in a state in which the pressing portion-side end part of the plate-like portion is withdrawn from the accommodation hole of the swing restriction portion provided in the holding portion in the work equipment holder in FIG. 7;

FIG. 18 is a left side view schematically illustrating the work equipment holder in FIG. 1 in a state in which the pressing portion-side end part of the plate-like portion is opened as a result of an operation portion of the plate-like portion being pushed toward the holding portion;

FIG. 19 is a left side view schematically illustrating the work equipment holder in FIG. 18 as viewed from the operation portion side;

FIG. 20 is a left side view schematically illustrating the work equipment holder in FIG. 1 in a state of being attached to a belt;

FIG. 21 is a bottom view schematically illustrating a modification of the holder in FIG. 1, in which the pressing portion-side end part of the plate-like portion is accommodated in the accommodation hole of the swing restriction portion provided in the holding portion in a state of being separated from the holding portion;

FIG. 22 is a left side view schematically illustrating a work equipment holder according to Embodiment 2 of the present disclosure in a state of being attached to a belt;

FIG. 23A is a right side view schematically illustrating a work equipment holder according to Embodiment 3 of the present disclosure in a state in which the pressing portion-side end part of the plate-like portion is accommodated in an accommodation recess formed in another swing restriction portion;

FIG. 23B is a right side view schematically illustrating the work equipment holder in FIG. 23A in a state in which the pressing portion-side end part of the plate-like portion is withdrawn from the accommodation recess of the swing restriction portion as a result of the plate-like portion being moved to the operation portion side relative to the holding portion;

FIG. 23C is a right side view schematically illustrating the work equipment holder in FIG. 23B in a state in which the pressing portion-side end part of the plate-like portion is opened relative to the holding portion; and

FIG. 24 is a perspective view schematically illustrating an example of work equipment with a bracket.

### DETAILED DESCRIPTION

Some exemplary embodiments of a work equipment holder according to the present disclosure will be described below with reference to the drawings.

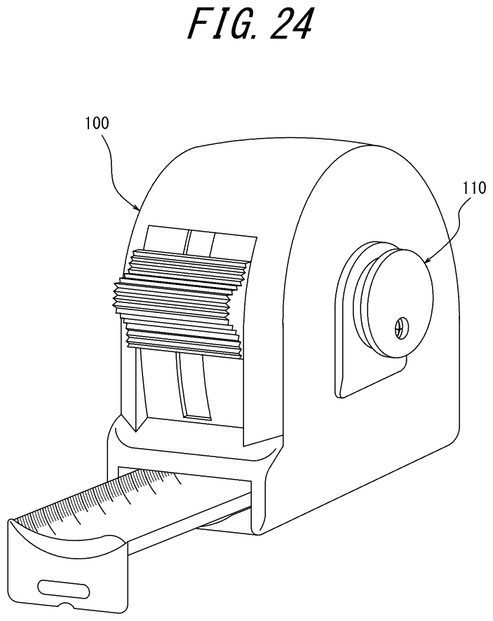

The work equipment holder is a device for attaching work equipment to a belt. For example, the work equipment holder is used for a user to carry work equipment on a work belt worn around the body. Examples of the work equipment include tools (hammers, crowbars, ratchet wrenches, electric screwdrivers, tape measures, etc.), and bags and tool holders for storing the tools. In the present disclosure, FIG. 24 illustrates work equipment 100 with a bracket. In the present disclosure, the work equipment 100 is integrally provided with a bracket 110. In the present disclosure, the work equipment 100 is a tape measure. The bracket 110 allows the work equipment 100 to be detachably attached to a work equipment holder 1A.

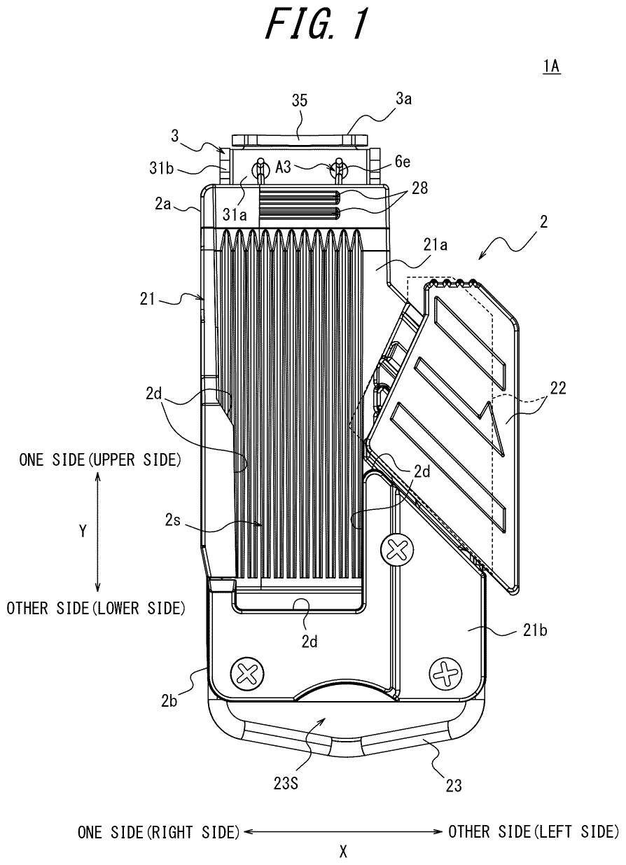

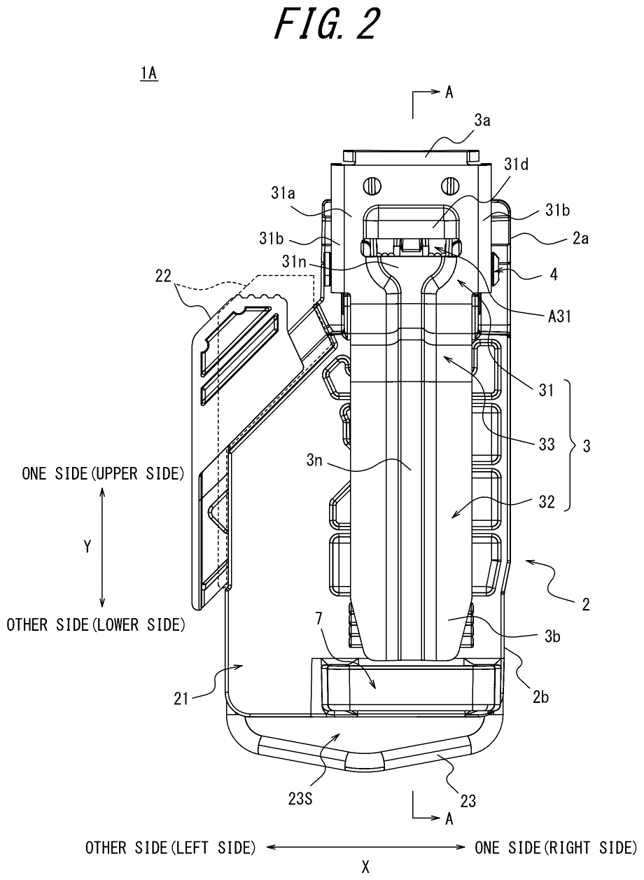

FIG. 1 schematically illustrates a work equipment holder 1A (hereinafter also simply referred to as “holder 1A”) according to Embodiment 1 of the present disclosure from the front side. FIG. 2 schematically illustrates the holder 1A in FIG. 1 from the rear side. FIGS. 1 and 2 illustrate a state in which a pressing portion-side end part 3b of a plate-like portion 3 (described later) is withdrawn from a swing restriction portion 7 (described later), as can be seen from FIG. 2.

Here, the term “front side” refers to the side opposite to the side facing the user's body when the holder 1A is worn by the user, that is, the side farther from the user's body. The term “rear side” refers to the side facing the user's body when the holder 1A is worn by the user, that is, the side closer to the user's body.

In FIG. 1, the X direction is the width direction of the holder 1A (hereinafter also simply referred to as “width direction”). The width direction is the left-right direction when the holder 1A is worn by the user. In the drawing, the Y direction is the length direction of the holder 1A (hereinafter also simply referred to as “length direction”). The length direction is the up-down direction when the holder 1A is worn by the user. In the present disclosure, the holder 1A has a substantially rectangular external shape. In the present disclosure, the holder 1A is shorter in width dimension than in length dimension, as illustrated in FIG. 1. The relationship between the width and length of the holder 1A may be, however, changed as appropriate. The external shape of the holder 1A may also be changed as appropriate.

The holder 1A includes a holding portion 2 that holds the work equipment 100 on the front side. In the present disclosure, the holding portion 2 includes a main body portion 21, a stopper member 22, and a safety rope attachment portion 23.

In the present disclosure, the main body portion 21 has a substantially rectangular external shape. In the present disclosure, the main body portion 21 is shorter in width dimension than in length dimension, as illustrated in FIG. 1. The relationship between the width and length of the main body portion 21 may be, however, changed as appropriate. The external shape of the main body portion 21 may also be changed as appropriate.

In the present disclosure, the main body portion 21 includes a notch portion 2d that defines a holding position 2s where the work equipment 100 is held and guides the bracket 110 provided on the work equipment 100 to the holding position 2s. In the present disclosure, the notch portion 2d extends in the length direction. In the present disclosure, two notch portions 2d facing each other in the width direction are arranged on the main body portion 21 so as to extend in the up-down direction when the holder 1A is worn by the user. In the present disclosure, each notch portion 2d is open on one side (upper side) in the length direction and closed on the other side (lower side) in the length direction. In the present disclosure, the open part of the notch portion 2d is located above the center of the main body portion 21 when the holder 1A is worn by the user. In the present disclosure, the holding position 2s is located below the center of the main body portion 21 when the holder 1A is worn by the user. In this case, the center of gravity of the holder 1A when the work equipment 100 is held is located on the lower side. Accordingly, the work equipment 100 can be stably carried via the holder 1A.

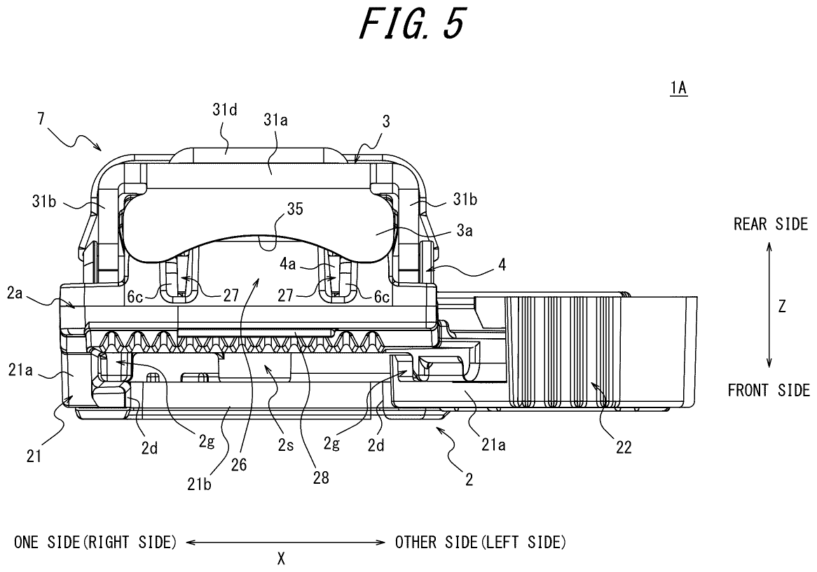

In the present disclosure, the main body portion 21 includes a base plate 21a and a sub-plate 21b. In the present disclosure, a U-shaped notch portion 2d is formed in the sub-plate 21b, as illustrated in FIG. 1. The sub-plate 21b is attached to the front side of the base plate 21a. As a result, a guide groove 2g is formed between the base plate 21a and the sub-plate 21b, as illustrated in FIG. 5. The guide groove 2g communicates with the holding position 2s so as to guide the bracket 110 provided on the work equipment 100 to the holding position 2s. Thus, the notch portion 2d guides the work equipment 100 to the holding position 2s via the bracket 110 provided on the work equipment 100, and positions the work equipment 100 at the holding position 2s.

With reference to FIG. 1, in the present disclosure, the notch portion 2d is disposed closer to one side (right side) in the width direction than the center of the main body portion 21. In the present disclosure, the notch portion 2d is located to the right of the center of the main body portion 21 when the holder 1A is worn by the user. In the present disclosure, the stopper member 22 is disposed closer to the other side (left side) in the width direction than the center of the main body portion 21. In the present disclosure, the stopper member 22 is located to the left of the center of the main body portion 21 when the holder 1A is worn by the user.

In the present disclosure, the stopper member 22 detachably fixes the bracket 110 provided on the work equipment 100 at the holding position 2s. In the present disclosure, the stopper member 22 has an initial position indicated by the dashed line in FIG. 1. In the present disclosure, the stopper member 22 is biased toward the position indicated by the dashed line in FIG. 1 by using a biasing member (not illustrated), such as a coil spring, disposed in the main body portion 21. Meanwhile, in the present disclosure, the stopper member 22 can be slid in an obliquely downward-left direction relative to the main body portion 21 against the biasing force (elastic force) of the biasing member.

In the present disclosure, when the bracket 110 provided on the work equipment 100 is inserted into the notch portion 2d and moved toward the holding position 2s, the bracket 110 slides the stopper member 22 in the obliquely downward-left direction relative to the main body portion 21 against the biasing force (elastic force) of the biasing member. Thus, the bracket 110 pushes the stopper member 22 away to the position indicated by the solid line in FIG. 1 and then reaches the holding position 2s. After the bracket 110 passes the stopper member 22 and reaches the holding position 2s, the stopper member 22 automatically returns from the position indicated by the solid line to the position indicated by the dashed line in FIG. 1 due to the biasing force (restoring force) of the biasing member. At this time, the stopper member 22 narrows the width dimension of the notch portion 2d to prevent the bracket 110 from moving upward from the holding position 2s. In this way, the bracket 110 is retained at the holding position 2s so as not to slip out. Thus, the work equipment 100 can be fixed at the holding position 2s of the main body portion 21 simply by inserting the bracket 110 into the notch portion 2d and then moving it along the notch portion 2d to the holding position 2s

On the other hand, to detach the work equipment 100 from the holder 1A, the user pushes the stopper member 22 indicated by the dashed line in the obliquely downward-left direction relative to the main body portion 21. As a result of the stopper member 22 being slid from the position indicated by the dashed line to the position indicated by the solid line in FIG. 1 against the biasing force (elastic force) of the biasing member, the width dimension of the notch portion 2d expands. This allows the bracket 110 provided on the work equipment 100 to move upward along the notch portion 2d. Thus, the work equipment 100 can be easily detached from the holder 1A simply by pulling the work equipment 100 upward while pushing in the stopper member 22.

The safety rope attachment portion 23 is provided at a pressing portion-side end part 2b of the holding portion 2. In the present disclosure, the pressing portion-side end part 2b of the holding portion 2 constitutes the end on the other side in the long side direction of the holding portion 2 (i.e., the lower end part of the holding portion 2). In the present disclosure, a rope insertion opening 23S is formed between the main body portion 21 and the safety rope attachment portion 23. In the present disclosure, a safety rope (not illustrated) can be passed through the rope insertion opening 23S. By attaching the safety rope to the safety rope attachment portion 23, the safety rope can be used as a lifeline. The safety rope attachment portion 23 may be omitted.

With reference to FIG. 2, the holder 1A includes the plate-like portion 3 disposed on the rear side of the holding portion 2. As illustrated in FIG. 2, the width direction of the plate-like portion 3 is the left-right direction when the holder 1A is worn by the user. Moreover, as illustrated in FIG. 2, the length direction of the plate-like portion 3 is the up-down direction when the holder 1A is worn by the user. In the present disclosure, the plate-like portion 3 has a rectangular external shape. In the present disclosure, the plate-like portion 3 is shorter in width dimension than in length dimension, as illustrated in FIG. 2. The relationship between the width and length of the plate-like portion 3 may be, however, changed as appropriate. The external shape of the plate-like portion 3 may also be changed as appropriate.

As illustrated in FIG. 2, the plate-like portion 3 includes an operation portion 31, a pressing portion 32, and an inclined portion 33. In the present disclosure, the plate-like portion 3 is a plate-like member obtained by integrally forming the operation portion 31, the pressing portion 32, and the inclined portion 33. In the present disclosure, the plate-like portion 3 may be formed from a metal plate material such as iron, stainless steel, or an aluminum alloy, or a resin plate material such as engineering plastic. In the case where a metal plate material is used, the plate-like portion 3 may be manufactured by press working. In the case where a resin plate material is used, the plate-like portion 3 may be manufactured by injection molding. The plate-like portion 3 may also be manufactured by an additive manufacturing method.

In the present disclosure, the operation portion 31 is disposed on one side (upper side) in the length direction. In the present disclosure, the operation portion 31 is located above the center of the plate-like portion 3 when the holder 1A is worn by the user. In the present disclosure, the pressing portion 32 is disposed on the other side (lower side) in the length direction. In the present disclosure, the pressing portion 32 is located below the center of the plate-like portion 3 when the holder 1A is worn by the user. In the present disclosure, the inclined portion 33 is interposed between the operation portion 31 and the pressing portion 32, and connects the operation portion 31 and the pressing portion 32 to each other.

In the present disclosure, the operation portion 31 includes a push-in portion 31a that the user can press with a finger or the like. In the present disclosure, the push-in portion 31a, together with the pressing portion 32 and the inclined portion 33, forms one continuous flat plate shape.

In the present disclosure, the operation portion 31 is provided with two side walls 31b. The two side walls 31b are spaced apart in the width direction. Each of the two side walls 31b extends toward the holding portion 2. Specifically, each of the two side walls 31b extends in the thickness direction. Here, the thickness direction is a direction orthogonal to both the length direction and the width direction. In the present disclosure, the two side walls 31b are connected to the respective ends (right and left ends) in the width direction of the push-in portion 31a. In the present disclosure, each side wall 31b is a plate-like side wall extending in both the length direction and the thickness direction.

In the present disclosure, the operation portion 31 is also provided with an operation portion-side end part 3a of the plate-like portion 3. In the present disclosure, the operation portion-side end part 3a of the plate-like portion 3 constitutes the end part on one side (upper end part) in the length direction of the plate-like portion 3. The operation portion-side end part 3a also extends in the thickness direction. In other words, in the present disclosure, the operation portion-side end part 3a also extends toward the holding portion 2. In the present disclosure, the operation portion-side end part 3a is connected to the end on one side (upper end) in the length direction of the push-in portion 31a. In the present disclosure, the operation portion-side end part 3a is a plate-like side wall extending in both the width direction and the thickness direction.

On the other hand, in the present disclosure, the pressing portion-side end part 3b of the plate-like portion 3 constitutes the end part on the other side (lower end part) in the length direction of the plate-like portion 3. The pressing portion-side end part 3b tapers toward the tip (i.e., the other side in the length direction). Alternatively, the pressing portion-side end part 3b may be formed straight with a uniform width dimension. In the case where the pressing portion-side end part 3b is straight, for example, looseness between the plate-like portion 3 and the swing restriction portion 7 (described later) can be prevented.

In the present disclosure, it is preferable that a groove or a protrusion is formed on the push-in portion 31a of the operation portion 31. In the present disclosure, a groove 31n and a protrusion 31d are formed on the push-in portion 31a. In the present disclosure, the groove 31n functions as a receiving portion that can receive the user's finger, and the protrusion 31d functions as a hook for the user's finger.

In the present disclosure, an opening A31 is formed between the groove 31n and the protrusion 31d. This reduces the weight of the plate-like portion 3 and makes it easier to press-work the plate-like portion 3. In the present disclosure, the groove 31n is formed by a bent recess resulting from bending the push-in portion 31a toward the holding portion 2. In the present disclosure, the protrusion 31d is formed by a bent protrusion resulting from bending the push-in portion 31a toward the side opposite from the holding portion 2.

In the present disclosure, the plate-like portion 3 is formed with a bent recess 3n. the present disclosure, the bent recess 3n results from bending the plate-like portion 3 toward the holding portion 2 along its length. In the present disclosure, the bent recess 3n can be formed between the operation portion 31 and the pressing portion 32. In the present disclosure, the bent recess 3n extends from the pressing portion-side end part 3b to the operation portion 31. In the present disclosure, the bent recess 3n extends from the end on the other side (lower end) in the length direction of the plate-like portion 3 toward the one side (upper side) in the length direction, and is connected to the groove 31n. Accordingly, in the present disclosure, the groove 31n and the bent recess 3n can be integrally formed, for example, by press working.

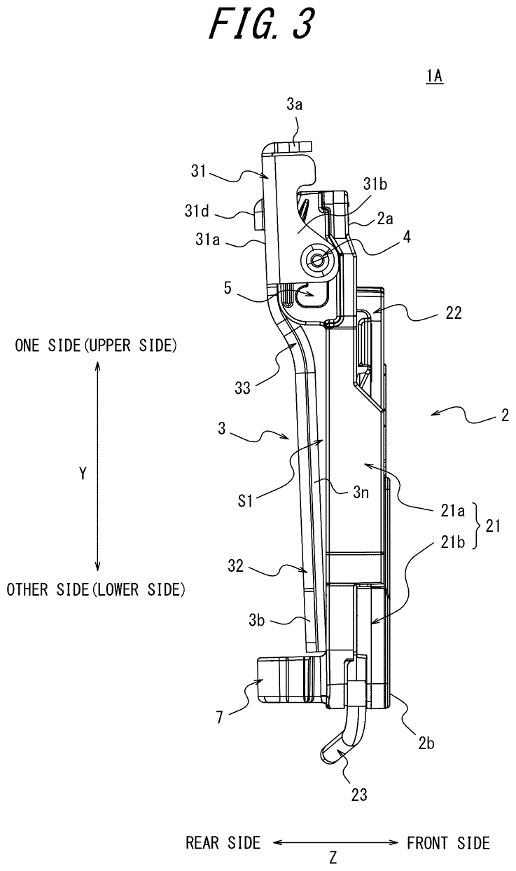

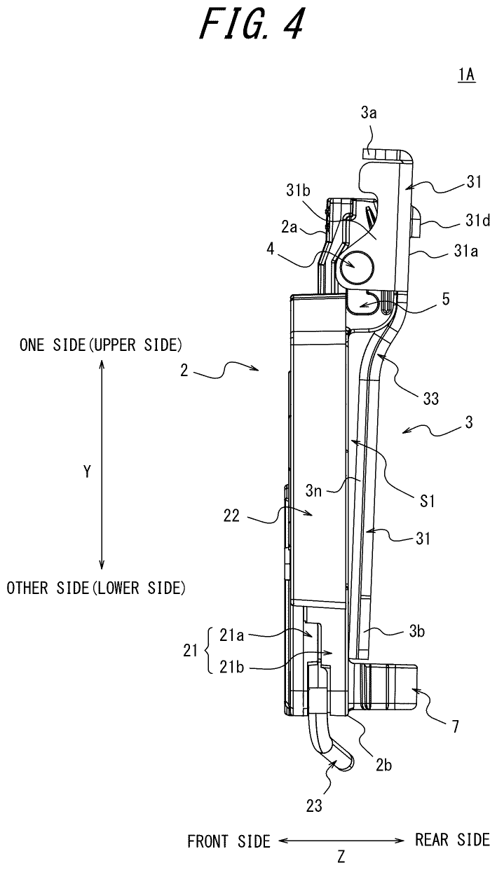

FIG. 3 schematically illustrates the holder 1A as viewed from one side (right side) in the width direction. FIG. 4 schematically illustrates the holder 1A as viewed from the other side (left side) in the width direction. In FIG. 3, the Z direction is the thickness direction of the holder 1A.

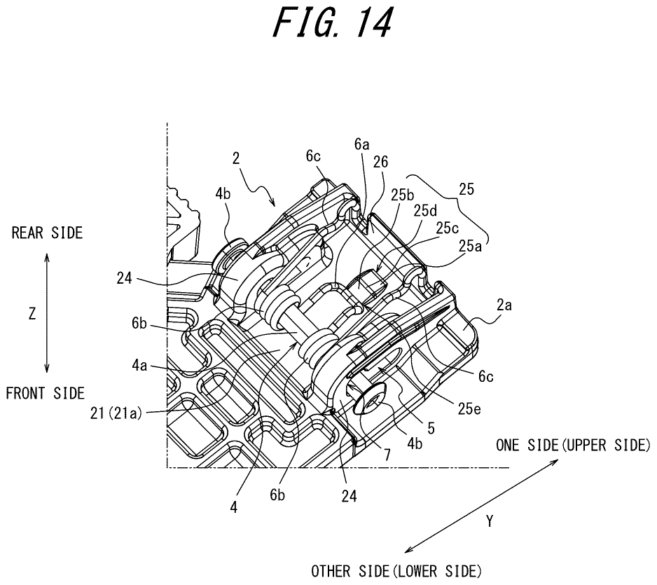

The holder 1A includes a connecting pin 4 that swingably connects the holding portion 2 and the plate-like portion 3. In the present disclosure, the connecting pin 4 is attached to each side wall 31b of the operation portion 31 and passes through a long hole 5 formed in the holding portion 2. Accordingly, in the present disclosure, the plate-like portion 3 can swing about the connecting pin 4 as a pivot relative to the holding portion 2. In the present disclosure, the connecting pin 4 includes a shaft 4a and flanges 4b attached to both ends of the shaft 4a, as illustrated for example in FIG. 14. As illustrated in FIG. 3, the plate-like portion 3 forms a gap S1 between the pressing portion 32 and the holding portion 2. The gap S1 can be closed by moving the pressing portion-side end part 3b of the plate-like portion 3 toward the holding portion 2 about the connecting pin 4 as a pivot. In the present disclosure, the pressing portion-side end part 3b of the plate-like portion 3 is in contact with the holding portion 2.

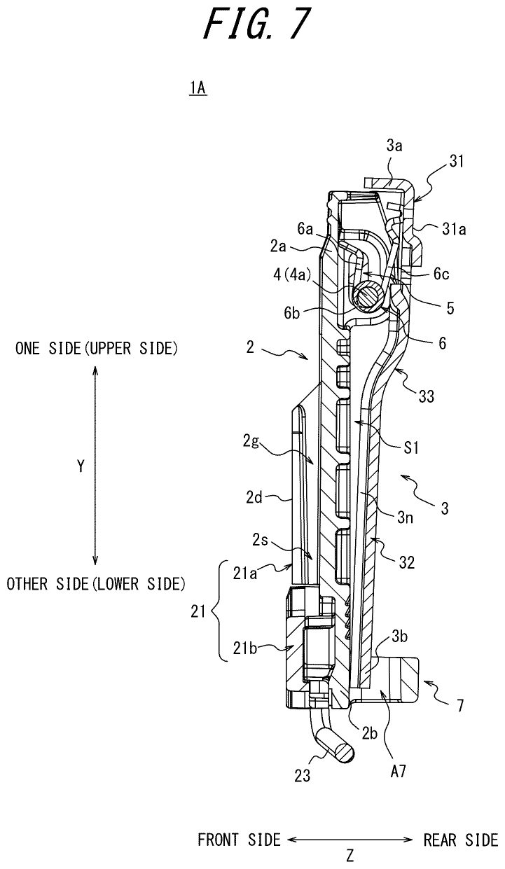

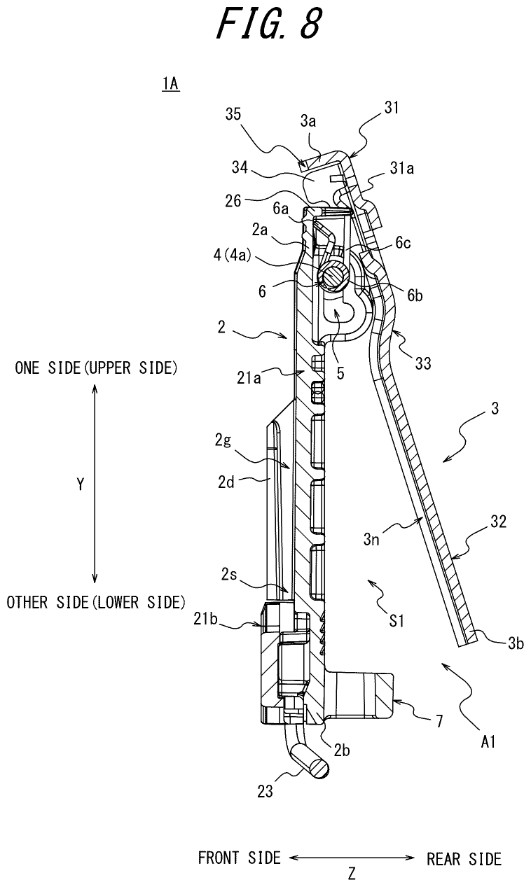

FIG. 7 schematically illustrates, in a sectional view along line A-A in FIG. 2, a state in which the pressing portion-side end part 3b of the plate-like portion 3 is accommodated in an accommodation hole A7 formed in the swing restriction portion 7 as a result of the plate-like portion 3 being moved along the long hole 5 formed in the holding portion 2 to its limit on the pressing portion side (other side in the length direction). FIG. 8 schematically illustrates, in a sectional view along line A-A in FIG. 2, a state in which the pressing portion-side end part 3b of the plate-like portion 3 is opened after the plate-like portion 3 is moved along the long hole 5 formed in the holding portion 2 to its limit on the operation portion side (one side in the length direction).

The holder 1A includes a torsion spring 6 attached to the connecting pin 4. The torsion spring 6 is an elastic member that biases the operation portion 31 of the plate-like portion 3 away from the holding portion 2 to bias the pressing portion 32 of the plate-like portion 3 so as to approach the holding portion 2 about the connecting pin 4 as a pivot. In other words, as illustrated in FIG. 7, in the initial state of the holder 1A, the torsion spring 6 applies a biasing force to the operation portion 31 of the plate-like portion 3 so that the pressing portion-side end part 3b of the plate-like portion 3 will approach the holding portion 2. Thus, in the present disclosure, the pressing portion-side end part 3b of the plate-like portion 3 can close the gap S1 between the holding portion 2 and the pressing portion 32 of the plate-like portion 3 in the initial state of the holder 1A.

In the present disclosure, the torsion spring 6 includes one folded portion 6a, two coil portions 6b, and two arm portions 6c. In the present disclosure, the torsion spring 6 is obtained by integrally forming the folded portion 6a, the two coil portions 6b, and the two arm portions 6c using a single wire material.

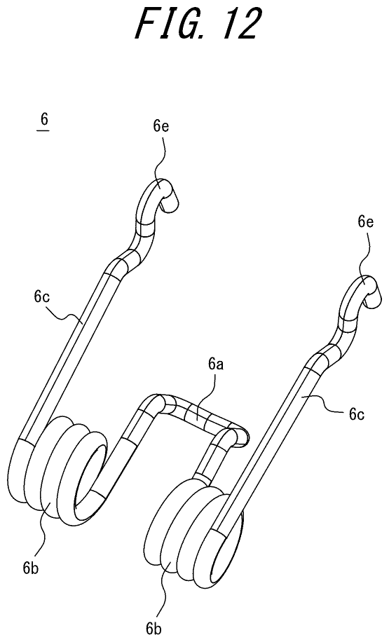

FIG. 12 schematically and perspectively illustrates the torsion spring 6. In the present disclosure, one end of the folded portion 6a is connected to one of the two arm portions 6c via one of the two coil portions 6b. In the present disclosure, the other end of the folded portion 6a is connected to the other of the two arm portions 6c via the other of the two coil portions 6b.

For example, in the present disclosure, the torsion spring 6 is attached to the connecting pin 4, as illustrated in FIG. 7. In the present disclosure, the shaft 4a of the connecting pin 4 passes through the inside of the coil portions 6b of the torsion spring 6. This allows the torsion spring 6 to move integrally with the connecting pin 4.

In the present disclosure, the folded portion 6a biases the holding portion 2. The folded portion 6a biases the holding portion 2 away from the operation portion 31 of the plate-like portion 3. In the present disclosure, the folded portion 6a biases an operation portion-side end part 2a of the holding portion 2. In the present disclosure, the operation portion-side end part 2a of the holding portion 2 constitutes the end part on one side (upper end part) in the length direction of the holding portion 2. Meanwhile, the two arm portions 6c each bias the plate-like portion 3. The two arm portions 6c each bias the plate-like portion 3 so that the operation portion 31 of the plate-like portion 3 will move away from the operation portion-side end part 2a of the holding portion 2.

The long hole 5 through which the connecting pin 4 slidably passes is formed the holding portion 2. In the present disclosure, the long hole 5 extends so that the plate-like portion 3 can move toward both the operation portion side and the pressing portion side. In the present disclosure, the long hole 5 extends in the length direction. This al lows the plate-like portion 3, together with the connecting pin 4, to move along the long hole 5 to both one side (operation portion side) and the other side (pressing portion side) in the length direction. Therefore, as a result of the connecting pin 4 sliding along the long hole 5 toward the one side in the length direction, the plate-like portion 3 can be moved to the operation portion side (upward) relative to the holding portion 2. Moreover, as a result of the connecting pin 4 sliding along the long hole 5 toward the other side in the length direction, the plate-like portion 3 can be moved to the pressing portion side (downward) relative to the holding portion 2.

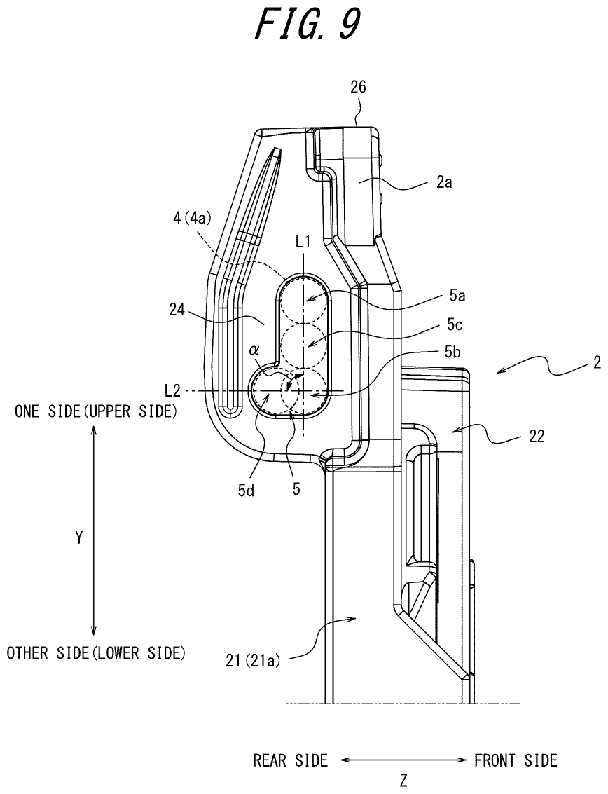

FIG. 9 schematically illustrates, in an enlarged manner, the vicinity of the long hole 5 of the holding portion 2. In the present disclosure, the holding portion 2 includes a mount portion 24. In the present disclosure, the mount portion 24 is provided on the rear surface (back surface) of the main body portion 21 and protrudes toward the plate-like portion 3.

In the present disclosure, the long hole 5 is formed in the mount portion 24. In the present disclosure, the long hole 5 penetrates the mount portion 24 in the width direction. In the present disclosure, two mount portions 24 are provided on the main body portion 21, spaced apart in the width direction (see, for example, FIG. 14). In the present disclosure, the long hole 5 is formed in each of the two mount portions 24.

As illustrated in FIG. 9, in the present disclosure, the long hole 5 includes an operation portion-side end part 5a, a pressing portion-side end part 5b, and an intermediate part 5c. In the present disclosure, the operation portion-side end part 5a of the long hole 5 is disposed on one side (upper side) in the length direction, and the pressing portion-side end part 5b of the long hole 5 is disposed on the other side (lower side) in the length direction. The intermediate part 5c of the long hole 5 is interposed between and connected to the operation portion-side end part 5a and the pressing portion-side end part 5b. The connecting pin 4 passing through the long hole 5 can be attached to the side wall 31b of the operation portion 31 by caulking (swaging) the connecting pin 4 in the axial direction. However, if the connecting pin 4 is caulked in the axial direction, the outer diameter of the shaft 4a of the connecting pin 4 may increase. In this case, it is preferable that the width of the long hole 5 is larger than the outer diameter of the shaft 4a.

In the present disclosure, the shaft 4a of the connecting pin 4 can be slidably positioned at each of the operation portion-side end part 5a, the pressing portion-side end part 5b, and the intermediate part 5c, as indicated by the dashed lines in FIG. 9. In the present disclosure, the plate-like portion 3 can move the shaft 4a of the connecting pin 4 toward the one side in the length direction until the shaft 4a of the connecting pin 4 moves from the pressing portion-side end part 5b through the intermediate part 5c to the operation portion-side end part 5a of the long hole 5. That is, in the present disclosure, the plate-like portion 3 can move the shaft 4a of the connecting pin 4 to the operation portion side (upper side) of the plate-like portion 3 until the shaft 4a reaches the operation portion-side end part 5a of the long hole 5. Moreover, in the present disclosure, the plate-like portion 3 can move the shaft 4a of the connecting pin 4 toward the other side in the length direction until the shaft 4a of the connecting pin 4 moves from the operation portion-side end part 5a through the intermediate part 5c to the pressing portion-side end part 5b of the long hole 5. That is, in the present disclosure, the plate-like portion 3 can move the shaft 4a of the connecting pin 4 to the pressing portion side (lower side) of the plate-like portion 3 until the shaft 4a reaches the pressing portion-side end part 5b of the long hole 5. Furthermore, in the present disclosure, when the shaft 4a of the connecting pin 4 is located at the intermediate part 5c of the long hole 5, the plate-like portion 3 can position at an intermediate position between the operation portion-side end part 5a and the pressing portion-side end part 5b.

In the present disclosure, a relief hole 5d extending in a direction away from the holding portion 2 is connected to the pressing portion-side end part 5b of the long hole 5. In the present disclosure, the relief hole 5d also penetrates the mount portion 24 in the width direction. In the present disclosure, the relief hole 5d extends from the front side toward the rear side and is connected to the pressing portion-side end part 5b of the long hole 5.

In the present disclosure, the shaft 4a of the connecting pin 4 can be moved from the position of the pressing portion-side end part 5b of the long hole 5 to the position of the relief hole 5d, as indicated by the dashed lines in FIG. 9. That is, in the present disclosure, the shaft 4a of the connecting pin 4 can be located at the relief hole 5d, as indicated by the dashed lines in FIG. 9. In the present disclosure, when the shaft 4a of the connecting pin 4 is located at the position of the relief hole 5d, the plate-like portion 3 cannot be moved to any of the operation portion side and the pressing portion side. That is, when the shaft 4a of the connecting pin 4 is located at the position of the relief hole 5d, the plate-like portion 3 cannot be moved toward any of the operation portion side and the pressing portion side.

In the present disclosure, the long hole 5 is an L-shaped long hole, as illustrated in FIG. 9. The L-shaped long hole 5 allows the plate-like portion 3 to move between the operation portion-side end part 5a and the pressing portion-side end part 5b through the intermediate part 5c, to the operation portion side or the pressing portion side. Additionally, the L-shaped long hole 5 allows the shaft 4a of the connecting pin 4 to move into the relief hole 5d by the biasing force of the torsion spring 6 after the shaft 4a reaches the pressing portion-side end part 5b. Accordingly, simply moving the plate-like portion 3 to the pressing portion side (lower side) relative to the holding portion 2 causes the plate-like portion 3 to be in a locked state in which the plate-like portion 3 cannot move to any of the operation portion side and the pressing portion side (up-down direction). The locked state of the plate-like portion 3 can be released simply by pushing the operation portion 31 of the plate-like portion 3 toward the holding portion 2 against the biasing force of the torsion spring 6 and then moving the plate-like portion 3 to the operation portion side (upper side) relative to the holding portion 2.

In the present disclosure, the relief hole 5d of the long hole 5 has a length greater than or equal to the radius of the shaft 4a of the connecting pin 4. In this case, the shaft 4a of the connecting pin 4 is securely positioned at the position of the relief hole 5d, and thus the plate-like portion 3 is firmly locked at the position on the pressing portion side (lower side). Alternatively, the relief hole 5d of the long hole 5 may have a length less than the radius of the shaft 4a of the connecting pin 4. In this case, the shaft 4a of the connecting pin 4 is lightly positioned at the position of the relief hole 5d, and thus the plate-like portion 3 is locked so that it can relatively easily move from the pressing portion side (lower side) to the operation portion side (upper side).

In the present disclosure, the long hole 5 is configured such that its length direction centerline L1 and its thickness direction centerline L2 are orthogonal to each other. Here, the length direction centerline L1 of the long hole 5 is a centerline extending in the length (up-down) direction through the center of the operation portion-side end part 5a, the center of the pressing portion-side end part 5b, and the center of the intermediate part 5c. The thickness direction centerline L2 of the long hole 5 is a centerline extending in the thickness (front-rear) direction through the center of the pressing portion-side end part 5b and the center of the relief hole 5d. The angle α formed between the length direction centerline L1 of the long hole 5 and the thickness direction centerline L2 of the long hole 5 on the one side in the length direction (operation portion side) to the rear side may be set as appropriate. For example, if the angle α is set to an acute angle instead of 90°, the plate-like portion 3 is locked more firmly at the position on the pressing portion side (lower side).

As illustrated in FIG. 9, the long hole 5 in the present disclosure is L-shaped by connecting the relief hole 5d to the pressing portion-side end part 5b of the long hole 5. Alternatively, the long hole 5 may be T-shaped by arranging the relief hole 5d at a position shifted from the pressing portion-side end part 5b of the long hole 5 toward the operation portion side (one side in the length direction). In such a case, the relief hole 5d may be provided such that the thickness direction centerline L2 of the long hole 5 is perpendicular to the length direction centerline L1 of the long hole 5, or such that the thickness direction centerline L2 of the long hole 5 is orthogonal to the length direction centerline L1 of the long hole 5. Furthermore, the long hole 5 may alternatively be I-shaped by omitting the relief hole 5d.

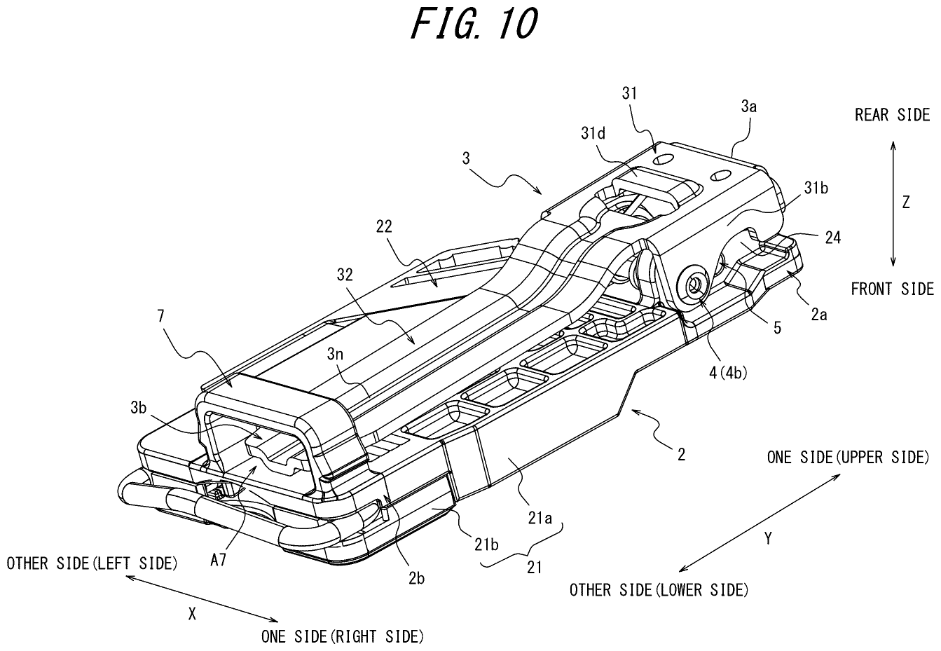

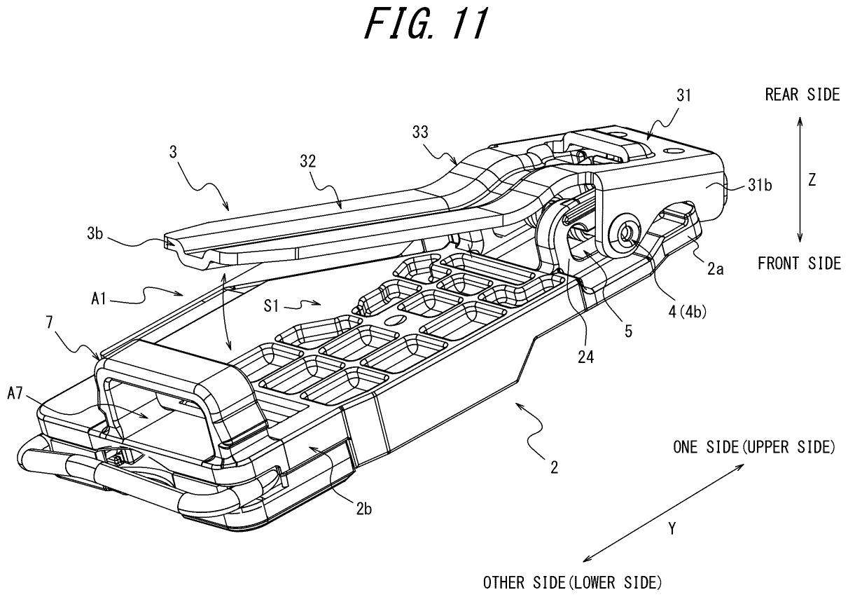

FIG. 10 schematically illustrates the holder 1A in a state in which the pressing portion-side end part 3b of the plate-like portion 3 is accommodated in the accommodation hole A7 formed in the swing restriction portion 7 as a result of the plate-like portion 3 being moved to the pressing portion side. FIG. 11 schematically illustrates the holder 1A in a state in which the pressing portion 32 of the plate-like portion 3 is separated from the holding portion 2 as a result of the operation portion 31 of the plate-like portion 3 being pushed toward the holding portion 2 after the plate-like portion 3 is moved to the operation portion side.

In the holder 1A, the swing restriction portion 7 is provided on the rear side of the holding portion 2. In the present disclosure, the swing restriction portion 7 is an arch portion bridged across the rear side of the holding portion 2, as illustrated in FIG. 10. In the present disclosure, the swing restriction portion 7 is bridged across the rear surface of the main body portion 21 so as to extend across the rear side of the main body portion 21 in the width direction.

In the present disclosure, the arch-shaped swing restriction portion 7 is disposed closer to one side (right side) in the width direction so as to be aligned with the plate-like portion 3 in the width direction. Moreover, in the present disclosure, the swing restriction portion 7 is spaced apart from the plate-like portion 3 in the length direction. As illustrated in FIG. 10, the accommodation hole A7 is formed inside the swing restriction portion 7. The accommodation hole A7 surrounds, together with the holding portion 2, the pressing portion-side end part 3b of the plate-like portion 3 in a state in which the plate-like portion 3 is moved to the pressing portion side (other side in the length direction). Meanwhile, the swing restriction portion 7 is positioned so that the pressing portion-side end part 3b of the plate-like portion 3 can be withdrawn from the accommodation hole A7 in a state in which the plate-like portion 3 is moved to the operation portion side (one side in the length direction). Therefore, as illustrated in FIG. 1 1, by pushing the operation portion 31 toward the holding portion 2 in a state in which the plate-like portion 3 is moved to the operation portion side, the pressing portion-side end part 3b of the plate-like portion 3 can be separated from the holding portion 2 about the connecting pin 4 as a pivot.

In detail, the swing restriction portion 7 is configured as follows: When the operation portion 31 of the plate-like portion 3 is pushed toward the holding portion 2 in a state in which the plate-like portion 3 is moved together with the connecting pin 4 along the long hole 5 to the pressing portion side (other side in the length direction), the swing restriction portion 7 restricts the swinging motion of the plate-like portion 3 by contacting the pressing portion 32 of the plate-like portion 3, as illustrated in FIG. 10. When the operation portion 31 of the plate-like portion 3 is pushed toward the holding portion 2 in a state in which the plate-like portion 3 is moved together with the connecting pin 4 along the long hole 5 to the operation portion side (one side in the length direction), the swing restriction portion 7 allows the plate-like portion 3 to swing about the connecting pin 4 as a pivot without contacting the pressing portion 32 of the plate-like portion 3, as illustrated in FIG. 11.

FIG. 14 schematically illustrates the relationship between the holding portion 2 and the torsion spring 6 in a state in which the pressing portion-side end part 3b of the plate-like portion 3 is accommodated in the accommodation hole A7 of the swing restriction portion 7 provided on the holding portion 2.

In the present disclosure, the holding portion 2 is provided with a raised portion 25 at which the torsion spring 6 is releasably locked.

In the present disclosure, the raised portion 25 is integrally provided on the rear surface of the holding portion 2, as illustrated in FIG. 14. The raised portion 25 extends in the length direction (up-down direction). In the present disclosure, the raised portion 25 includes an operation portion-side inclined surface 25a, a pressing portion-side inclined surface 25b, and a top part 25c. The operation portion-side inclined surface 25a, the pressing portion-side inclined surface 25b, and the top part 25c are integrally formed. In the present disclosure, the operation portion-side inclined surface 25a and the pressing portion-side inclined surface 25b are each inclined from the front side toward the rear side (i.e., toward the plate-like portion 3) as they approach the top part 25c.

In the present disclosure, an operation portion-side base portion 25d of the raised portion 25 is formed between the holding portion 2 and the operation portion-side inclined surface 25a. In the present disclosure, the operation portion-side base portion 25d of the raised portion 25 is formed between the main body portion 21 of the holding portion 2 and the operation portion-side inclined surface 25a.

In the present disclosure, a pressing portion-side base portion 25e of the raised portion 25 is formed between the holding portion 2 and the pressing portion-side inclined surface 25b. In the present disclosure, the pressing portion-side base portion 25e of the raised portion 25 is formed between the main body portion 21 of the holding portion 2 and the pressing portion-side inclined surface 25b.

As illustrated in FIG. 14, when the pressing portion-side end part 3b of the plate-like portion 3 is located in the accommodation hole A7 formed in the swing restriction portion 7, the folded portion 6a of the torsion spring 6 is located at the pressing portion-side base portion 25e of the raised portion 25. Thus, the torsion spring 6 is locked by the pressing portion-side base portion 25e at a position where the plate-like portion 3 is moved along the long hole 5 to its limit on the pressing portion side (other side in the length direction). The locking between the torsion spring 6 and the pressing portion-side base portion 25e is released when the folded portion 6a of the torsion spring 6 climbs over the top part 25c through the pressing portion-side inclined surface 25b.

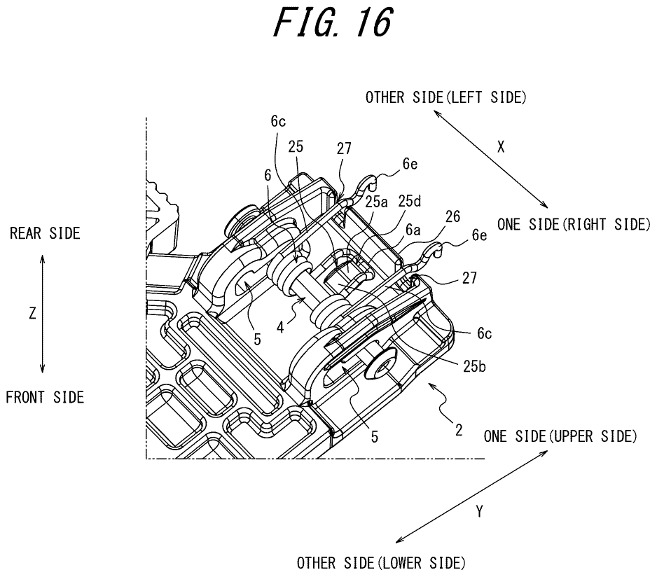

FIG. 16 schematically illustrates the relationship between the holding portion 2 and the torsion spring 6 in a state in which the pressing portion-side end part 3b of the plate-like portion 3 is withdrawn from the accommodation hole A7 formed in the swing restriction portion 7 provided on the holding portion 2.

As illustrated in FIG. 16, when the pressing portion-side end part 3b of the plate-like portion 3 is withdrawn from the accommodation hole A7 formed in the swing restriction portion 7, the folded portion 6a of the torsion spring 6 is located at the operation portion-side base portion 25d of the raised portion 25. Thus, the torsion spring 6 is locked by the operation portion-side base portion 25d at a position where the plate-like portion 3 is moved along the long hole 5 to its limit on the operation portion side (one side in the length direction). The locking between the torsion spring 6 and the operation portion-side base portion 25d is released when the folded portion 6a of the torsion spring 6 climbs over the top part 25c through the operation portion-side inclined surface 25a.

In other words, in the present disclosure, the raised portion 25 is configured such that the torsion spring 6 is releasably locked at at least one of a position where the plate-like portion 3 is moved along the long hole 5 to the pressing portion side of the plate-like portion 3 and a position where the plate-like portion 3 is moved along the long hole 5 to the operation portion 31 side of the plate-like portion 3. In the present disclosure, the raised portion 25 may be reinforced by, for example, plating or Teflon® (Teflon is a registered trademark in Japan, other countries, or both) coating to improve wear resistance. The raised portion 25 need not necessarily be integrally provided on the rear surface of the holding portion 2 and may be omitted. In the case where the raised portion 25 is omitted, it is preferable to perform wear-resistant treatment on the rear surface of the holding portion 2. An example of the wear-resistant treatment is to attach a resin sheet to the rear surface of the holding portion 2. As the resin sheet, a resin sheet having wear resistance may be used. A specific example of such a resin sheet is a wear-resistant resin sheet of polyacetal (POM) or the like.

With reference to FIG. 16, in the present disclosure, the operation portion-side end part 2a of the holding portion 2 is provided with an operation portion-side end wall 26. The operation portion-side end wall 26 extends from the operation portion-side end part 2a toward the rear side (plate-like portion 3 side) and also extends in the width direction. In the present disclosure, two slits 27 are formed in the operation portion-side end wall 26. The two slits 27 are disposed at respective positions corresponding to the arm portions 6c of the torsion spring 6. Each arm portion 6c of the torsion spring 6 can be inserted into and removed from the corresponding slit 27 from the tip part 6e of the arm portion 6c. As a result, the arm portions 6c of the torsion spring 6 can be moved to the operation portion side together with the plate-like portion 3 without interfering with the operation portion-side end wall 26.

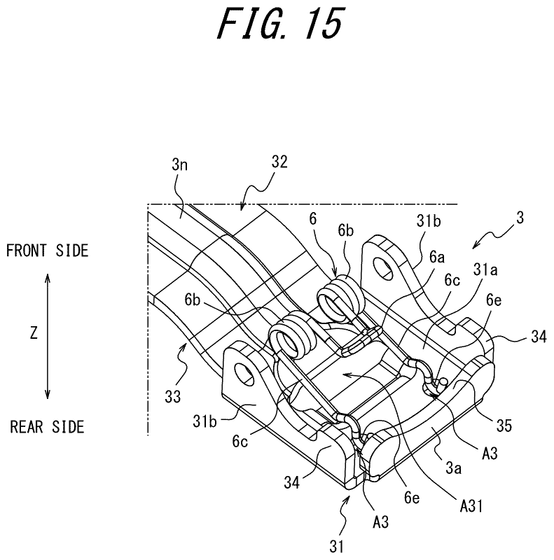

FIG. 15 schematically illustrates the relationship between the plate-like portion 3 and the torsion spring 6 in a state in which the pressing portion-side end part 3b of the plate-like portion 3 is accommodated in the accommodation hole A7 of the swing restriction portion 7 provided on the holding portion 2.

As illustrated in FIG. 15, in the present disclosure, the arm portions 6c of the torsion spring 6 are in contact with the operation portion 31 of the plate-like portion 3. In the present disclosure, the tip parts 6e of the arm portions 6c are fitted into through holes A3 formed in the push-in portion 31a of the operation portion 31. Thus, the arm portions 6c are fixed to the push-in portion 31a of the operation portion 31 with a simple structure. Meanwhile, the folded portion 6a of the torsion spring 6 rises toward the front side with the coil portions 6b attached to the connecting pin 4 (not illustrated) as a pivot, thereby closing the pressing portion-side end part 3b of the operation portion 31 from the holding portion 2 toward the front side.

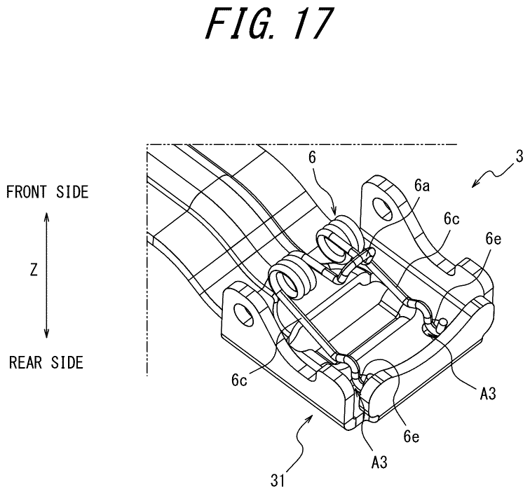

FIG. 17 schematically illustrates the relationship between the plate-like portion 3 and the torsion spring 6 in a state in which the pressing portion-side end part 3b of the plate-like portion 3 is withdrawn from the accommodation hole A7 formed in the swing restriction portion 7 provided on the holding portion 2.

As illustrated in FIG. 17, in the present disclosure, even in the state in which the pressing portion-side end part 3b of the plate-like portion 3 is withdrawn from the accommodation hole A7 of the swing restriction portion 7, the arm portions 6c of the torsion spring 6 are fixed to the operation portion 31 by means of the through holes A3. Meanwhile, as a result of the operation portion 31 of the plate-like portion 3 being pushed toward the holding portion 2, the folded portion 6a of the torsion spring 6 is compressed toward the rear side with the coil portion 6b attached to the connecting pin 4 (not illustrated) as a pivot, thereby opening the pressing portion 32 of the operation portion 31 from the holding portion 2 toward the rear side.

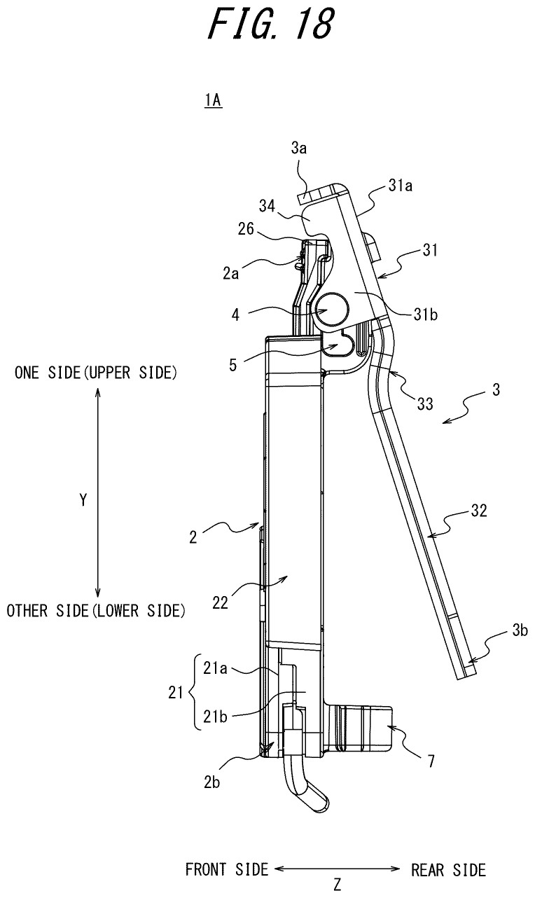

FIG. 18 schematically illustrates a state in which the pressing portion-side end part 3b of the plate-like portion 3 is opened as a result of the operation portion 31 of the plate-like portion 3 being pushed toward the holding portion 2 after the pressing portion-side end part 3b of the plate-like portion 3 is withdrawn from the accommodation hole A7 of the swing restriction portion 7.

In the present disclosure, the plate-like portion 3 includes a stopper 34 that prevents the plate-like portion 3, together with the connecting pin 4, from moving along the long hole 5 to the pressing portion side of the plate-like portion 3.

In the present disclosure, the stopper 34 is provided on the side wall 31b of the operation portion 31. In the present disclosure, the stopper 34 is a projection that projects from the side wall 31b toward the holding portion 2. As illustrated in FIG. 18, when the plate-like portion 3 is moved to the pressing portion side (lower side) in a state in which the pressing portion-side end part 3b of the plate-like portion 3 is open, the stopper 34 can come into contact with the operation portion-side end wall 26 of the holding portion 2. In the present disclosure, the distance in the length direction between the stopper 34 provided on the plate-like portion 3 and the operation portion-side end wall 26 of the holding portion 2 is set such that, when the plate-like portion 3 is moved to the pressing portion side (lower side) relative to the holding portion 2, the stopper 34 provided on the plate-like portion 3 contacts the operation portion-side end wall 26 of the holding portion 2 before the pressing portion-side end part 3b of the plate-like portion 3 reaches the swing restriction portion 7.

In other words, in the present disclosure, when the plate-like portion 3 is moved together with the connecting pin 4 along the long hole 5 to the pressing portion side of the plate-like portion 3 in a state in which the operation portion 31 of the plate-like portion 3 is pushed toward the holding portion 2, the stopper 34 comes into contact with the holding portion 2 before the pressing portion 32 of the plate-like portion 3 reaches the swing restriction portion 7, thereby preventing the plate-like portion 3 from moving together with the connecting pin 4 along the long hole 5 to the pressing portion side of the plate-like portion 3 while the pressing portion 32 of the plate-like portion 3 remains separated from the holding portion 2. In the present disclosure, the stopper 34 is configured to contact the outer wall surface of the operation portion-side end wall 26 of the holding portion 2. Here, a recess may be provided on the outer wall surface of the operation portion-side end wall 26 of the holding portion 2. In this case, the stopper 34 contacts the bottom surface of the recess provided on the outer wall surface of the operation portion-side end wall 26 of the holding portion 2, thereby preventing the plate-like portion 3 from moving to the pressing portion side while the pressing portion 32 of the plate-like portion 3 remains separated from the holding portion 2. For example, in the case where the stopper 34 is plate-like as in this embodiment, the recess may be a slit-shaped recess capable of accommodating the plate-like stopper 34.

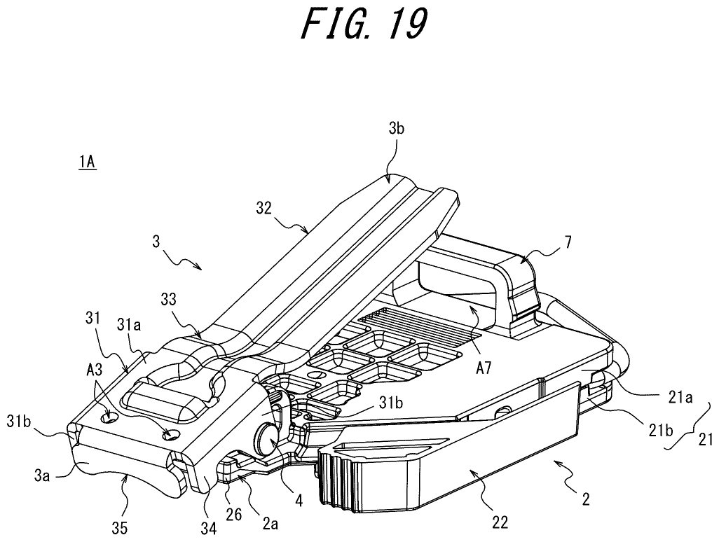

FIG. 19 schematically illustrates the holder 1A in FIG. 18 as viewed from the operation portion side.

In the present disclosure, the plate-like portion 3 includes the operation portion-side end part 3a extending toward the holding portion 2, as mentioned above. In the present disclosure, a depression 35 is formed at the holding portion-side end of the operation portion-side end part 3a. In the present disclosure, the depression 35 is formed as a curve that is convex toward the push-in portion 31a, as illustrated in FIG. 5. The holder 1A can be used, for example, by the user placing the index finger on the front side of the operation portion-side end part 2a of the holding portion 2 (for example, on the below-described protrusion 28) while placing the thumb on the push-in portion 31a of the operation portion 31 of the plate-like portion 3. In this case, it is assumed that the user's index finger may come into contact with the holding portion-side end of the operation portion-side end part 3a. The depression 35 can prevent the user's finger from contacting the holding portion-side end of the operation portion-side end part 3a when using the holder 1A. The depression 35 can also reduce the strain on the user's finger when the user's finger contacts the holding portion-side end of the operation portion-side end part 3a.

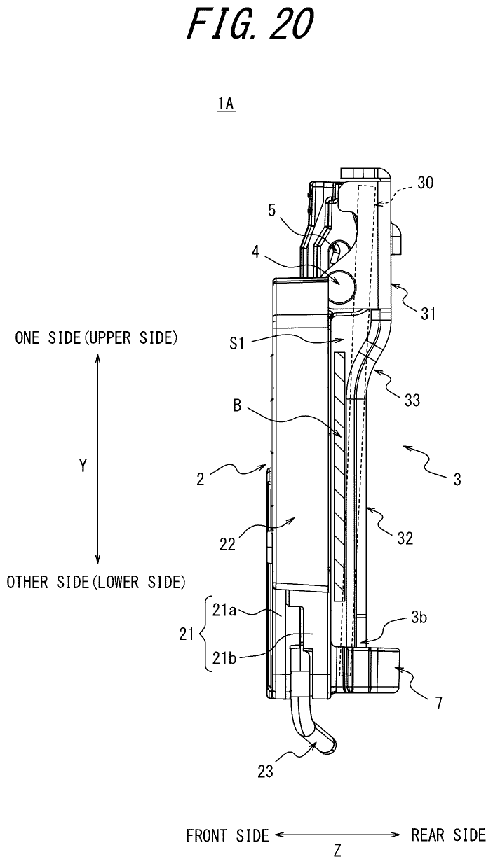

FIG. 20 schematically illustrates a state in which the holder 1A is attached to a belt B. In FIG. 20, the belt B is located in the gap S1 formed between the holding portion 2 and the plate-like portion 3. In the present disclosure, the belt B is sandwiched between the rear surface of the holding portion 2 and the pressing portion 32 of the plate-like portion 3.

In the present disclosure, the plate-like portion 3 includes the inclined portion 33. In the present disclosure, the inclined portion 33 is inclined toward the holding portion 2 as it approaches the pressing portion-side end part 3b of the plate-like portion 3 such that, when the operation portion 31 of the plate-like portion 3 is pushed toward the holding portion 2, the opposing surface of the pressing portion 32 of the plate-like portion 3 facing the holding portion 2 is parallel to the rear side of the holding portion 2 facing the opposing surface on the pressing portion side of the plate-like portion 3, as illustrated in FIG. 20.

In FIG. 20, the dashed line indicates a plate-like portion 30 having a straight shape. In the case of the plate-like portion 30, the gap S1 formed between the plate-like portion 30 and the holding portion 2 has an approximately right-triangular contour that inclines rearward toward the operation portion side (upper side). Therefore, in the case where the holder 1A is attached to the belt B with the operation portion 31 of the plate-like portion 3 located on the upper side, the holder 1A tends to incline frontward from the upper side toward the lower side. In such a case, for example, when the work equipment is a tool holder, it may be difficult to insert or remove tools.

In contrast, since the plate-like portion 3 includes the inclined portion 33, the gap S1 formed between the pressing portion 32 of the plate-like portion 3 and the holding portion 2 has an approximately rectangular contour as illustrated in FIG. 20. Therefore, in the case where the holder 1A is attached to the belt B with the operation portion 31 of the plate-like portion 3 located on the upper side, the holder 1A hardly inclines frontward from the upper side toward the lower side. Accordingly, for example if the work equipment is a tool holder, the tool holder is less likely to incline relative to the belt B, making it easier to put tools in and take them out.

An example of a method of using the holder 1A will be described below.

With reference to FIG. 7, when the plate-like portion 3 is located on the pressing portion side (other side in the length direction) relative to the holding portion 2, the pressing portion-side end part 3b of the plate-like portion 3 is accommodated in the accommodation hole A7 of the swing restriction portion 7. During this, the pressing portion-side end part 3b of the plate-like portion 3 is in contact with the holding portion 2 due to the biasing force of the arm portions 6c of the torsion spring 6. In addition, the connecting pin 4 attached to the plate-like portion 3 is located at the position of the relief hole 5d (see FIG. 9) of the long hole 5 due to the biasing force of the folded portion 6a of the torsion spring 6. Accordingly, as illustrated in FIG. 7, the plate-like portion 3 is fixed in a state in which the pressing portion-side end part 3b of the plate-like portion 3 is in contact with the holding portion 2 and is accommodated in the accommodation hole A7 of the swing restriction portion 7. FIG. 10 illustrates a perspective view of the state in FIG. 7.

To release the connecting pin 4 from being caught in the relief hole 5d, the operation portion 31 of the plate-like portion 3 is pushed toward the holding portion 2. As a result, the connecting pin 4 moves to the position of the pressing portion-side end part 5b against the biasing force of the torsion spring 6 (see FIG. 9). The pressing portion-side end part 5b is continuous with the operation portion-side end part 5a (see FIG. 9). Hence, the connecting pin 4 can move to the operation portion side (one side in the length direction) along the length direction centerline L1 of the long hole 5.

When the operation portion 31 of the plate-like portion 3 is pulled toward the operation portion side (one side in the length direction) while the operation portion 31 remains pushed toward the holding portion 2, the plate-like portion 3 moves to the operation portion side (one side in the length direction) as illustrated in FIG. 4. Here, the plate-like portion 3 moves to the operation portion side (one side in the length direction) while the pressing portion-side end part 3b of the plate-like portion 3 remains in contact with the holding portion 2 due to the biasing force of the torsion spring 6. As a result, the pressing portion-side end part 3b of the plate-like portion 3 can be withdrawn from the accommodation hole A7 of the swing restriction portion 7, as illustrated in FIG. 4. At this time, as illustrated in FIG. 16, the folded portion 6a of the torsion spring 6 climbs over the top part 25c of the raised portion 25 and then descends along the operation portion-side inclined surface 25a to be locked at the operation portion-side base portion 25d. Consequently, the plate-like portion 3 is locked by the operation portion-side base portion 25d at the position where it is moved along the long hole 5 to its limit on the operation portion side (one side in the length direction).

In the present disclosure, the push-in portion 31a is formed with the groove 31n and the protrusion 31d, as illustrated in FIG. 2. This allows the user to insert their finger into the groove 31n and hook it onto the protrusion 31d, thereby easily pulling the plate-like portion 3 toward the operation portion side (one side in the length direction) via the operation portion 31. Further, according to the present disclosure, narrowing the width dimension of the two side walls 31b reduces wobbling of the operation portion 31 in the left-right direction during use.

To open the pressing portion-side end part 3b of the plate-like portion 3, after the connecting pin 4 has reached the operation portion-side end part 5a (see FIG. 9) of the long hole 5, that is, after the plate-like portion 3 has been moved together with the connecting pin 4 along the long hole 5 to its limit on the operation portion side (one side in the length direction), the operation portion 31 of the plate-like portion 3 is further pushed toward the holding portion 2 against the biasing force of the torsion spring 6. As a result, the pressing portion-side end part 3b of the plate-like portion 3 can be opened relative to the holding portion 2 about the connecting pin 4 as a pivot, as illustrated in FIG. 8. FIG. 11 is a perspective view of the state in FIG. 8.

The above series of operations on the holder 1A can be performed, for example, by holding the holder 1A in one hand and using the thumb of the same hand.

When attaching the holder 1A to the belt B, for example, the belt B is passed through the gap S1 formed between the plate-like portion 3 and the holding portion 2 or the holder 1A is hooked onto the belt B from above, and then the push on the operation portion 31 of the plate-like portion 3 is released.

Specifically, in a state in which the pressing portion-side end part 3b of the plate-like portion 3 is opened as a result of pushing the operation portion 31 of the plate-like portion 3, the holder 1A is moved downward from above the belt B to pass the belt B through the opening A1 formed between the holding portion 2 and the pressing portion-side end part 3b of the plate-like portion 3 and accommodate it in the gap S1 formed between the holding portion 2 and the plate-like portion 3. The push on the operation portion 31 of the plate-like portion 3 is then released, as a result of which the pressing portion-side end part 3b of the plate-like portion 3 automatically closes so as to contact the holding portion 2 under the biasing force of the torsion spring 6. Subsequently, when the operation portion 31 of the plate-like portion 3 is pushed toward the pressing portion side (lower side), the plate-like portion 3 moves to the pressing portion side (lower side) relative to the holding portion 2. As a result, the pressing portion-side end part 3b of the plate-like portion 3 is accommodated in the accommodation hole A7 of the swing restriction portion 7 while the belt B remains accommodated in the gap S1 formed between the holding portion 2 and the plate-like portion 3, as illustrated in FIG. 20. At this time, as illustrated in FIG. 14, the folded portion 6a of the torsion spring 6 climbs over the top part 25c of the raised portion 25, then descends along the pressing portion-side inclined surface 25b, and is locked at the pressing portion-side base portion 25e. Consequently, the plate-like portion 3 is locked by the pressing portion-side base portion 25e at the position where it is moved along the long hole 5 to its limit on the pressing portion side (lower side).

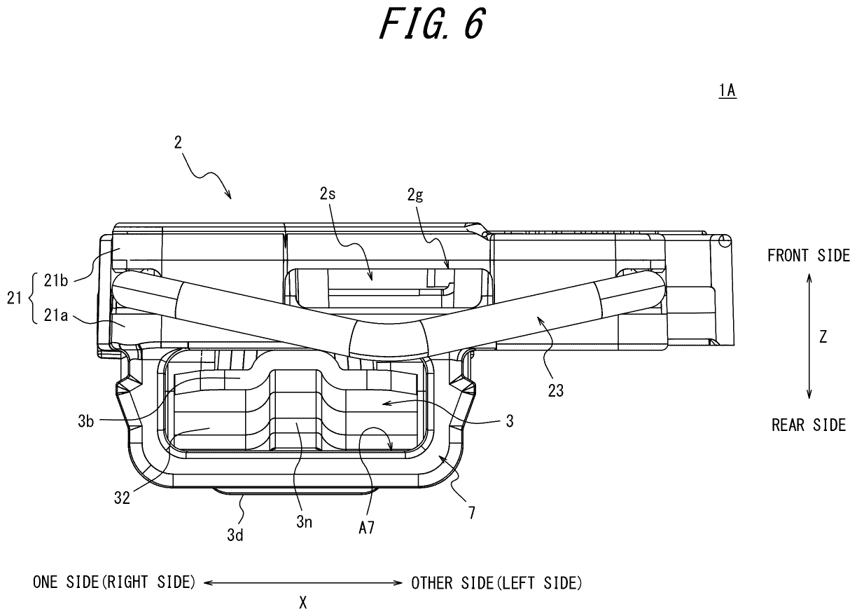

Moreover, when the plate-like portion 3 is moved together with the connecting pin 4 along the long hole 5 to its limit on the pressing portion side (lower side), the connecting pin 4 moves from the pressing portion-side end part 5b of the long hole 5 to the position of the relief hole 5d (see FIG. 9) under the biasing force of the folded portion 6a of the torsion spring 6. Consequently, the plate-like portion 3 is fixed in a state in which the pressing portion-side end part 3b of the plate-like portion 3 is accommodated in the accommodation hole A7 of the swing restriction portion 7, as illustrated in FIG. 20. If the plate-like portion 3 swings in a direction that opens the pressing portion-side end part 3b about the connecting pin 4 as a pivot, the pressing portion-side end part 3b of the plate-like portion 3 is surrounded by the swing restriction portion 7 and the main body portion 21 of the holding portion 2 as illustrated for example in FIG. 6, and therefore contacts the holding portion 2 or the swing restriction portion 7. Accordingly, the holder 1A is kept from falling off the belt B by accommodating the pressing portion-side end part 3b of the plate-like portion 3 in the accommodation hole A7 of the swing restriction portion 7.

As described above, the holder 1A can be later-attached to the belt B and can prevent, through a simple operation, the plate-like portion 3 from opening after being later-attached to the belt B. In addition, by maintaining the plate-like portion 3 in a closed state, the holder 1A can be stored compactly when not in use.

Moreover, the holder 1A can be easily removed from the belt B. When the operation portion 31 of the plate-like portion 3 is pushed toward the holding portion 2 against the biasing force of the torsion spring 6 in a state in which the holder 1A is attached to the belt B as illustrated in FIG. 20, the connecting pin 4 moves from the position of the relief hole 5d to the position of the pressing portion-side end part 5b of the long hole 5 illustrated in FIG. 9. Accordingly, after the operation portion 31 of the plate-like portion 3 is pushed in, the plate-like portion 3 can be pulled up toward the operation portion side (upper side) relative to the holding portion 2 along the long hole 5.

When the plate-like portion 3 is pulled up toward the operation portion side (upper side), the pressing portion-side end part 3b of the plate-like portion 3 is withdrawn from the accommodation hole A7 of the swing restriction portion 7 as illustrated for example in FIG. 3. This allows the pressing portion-side end part 3b of the plate-like portion 3 to freely open in the length (up-down) direction about the connecting pin 4 as a pivot. Hence, further pushing the operation portion 31 of the plate-like portion 3 toward the holding portion 2 against the biasing force of the torsion spring 6 can open the pressing portion-side end part 3b of the plate-like portion 3 about the connecting pin 4 as a pivot, as illustrated in FIG. 11. By lifting the holder 1A upward with the pressing portion-side end part 3b of the plate-like portion 3 open, the holder 1A can be easily removed from the belt B.

Then, when the push on the operation portion 31 of the plate-like portion 3 is released, the pressing portion-side end part 3b of the plate-like portion 3 automatically closes under the biasing force of the torsion spring 6, as illustrated for example in FIG. 3. After this, moving the plate-like portion 3 to the pressing portion side (other side in the length direction) restores the initial state illustrated in FIG. 7. Thus, the holder 1A can be easily removed from the belt B.

In addition, if, in a state in which the pressing portion-side end part 3b of the plate-like portion 3 is open relative to the holding portion 2 as illustrated in FIG. 11, the pressing portion-side end part 3b of the plate-like portion 3 is inserted into the opening of a pocket and then the push on the operation portion 31 of the plate-like portion 3 is released, the holding portion 2 and the pressing portion 32 of the plate-like portion 3 sandwich the pocket, so that the holder 1A can be firmly attached to the pocket.

In the present disclosure, the relief hole 5d is connected to the long hole 5, as illustrated in FIG. 9. In this case, the plate-like portion 3 is fixed in a state in which the pressing portion-side end part 3b of the plate-like portion 3 is accommodated in the accommodation hole A7 of the swing restriction portion 7, as illustrated for example in FIG. 7. This prevents the plate-like portion 3 from accidentally moving to the operation portion side (upper side) relative to the holding portion 2.

In the present disclosure, the holding portion 2 is provided with the raised portion 25 with which the torsion spring 6 is releasably locked at at least one of a position where the plate-like portion 3 is moved to its limit on the pressing portion side (see FIG. 14) and a position where the plate-like portion 3 is moved along the long hole 5 to its limit on the operation portion side (see FIG. 16), as illustrated in FIGS. 14 and 16. In this case, the plate-like portion 3 can be reliably positioned at both the position where it is moved to its limit on the pressing portion side (other side in the length direction) and the position where it is moved to its limit on the operation portion side (one side in the length direction). For example, in the case where the folded portion 6a of the torsion spring 6 biases the plate-like portion 3, the raised portion 25 may be provided on the plate-like portion 3.

In the present disclosure, the plate-like portion 3 includes the stopper 34 that prevents the plate-like portion 3 from moving, together with the connecting pin 4, along the long hole 5 to the pressing portion side of the plate-like portion 3 while the pressing portion-side end part 3b of the plate-like portion 3 remains separated from the holding portion 2, as illustrated for example in FIG. 18. This prevents the pressing portion-side end part 3b of the plate-like portion 3 from climbing over the swing restriction portion 7 without passing through the accommodation hole A7 of the swing restriction portion 7, even if the plate-like portion 3 is moved to the pressing portion side (other side in the length direction) while the pressing portion-side end part 3b of the plate-like portion 3 remains open.

In the present disclosure, the plate-like portion 3 includes the inclined portion 33 that inclines toward the holding portion 2 as it approaches the pressing portion-side end part 3b of the plate-like portion 3 so that, when the operation portion 31 of the plate-like portion 3 is pushed toward the holding portion 2, the pressing portion 32 of the plate-like portion 3 will be parallel to the rear side of the holding portion 2, as illustrated for example in FIG. 20. In the case where the holder 1A is attached to the belt B with the operation portion 31 of the plate-like portion 3 located on the upper side, the holder 1A hardly inclines frontward from the upper side toward the lower side. Accordingly, for example if the work equipment is a tool holder, it is easier to put tools in and take them out.

In the present disclosure, the torsion spring 6 includes one folded portion 6a, two coil portions 6b, and two arm portions 6c, the one folded portion 6a biases the holding portion 2, and the two arm portions 6c bias the plate-like portion 3, as illustrated for example in FIG. 7. A double torsion spring with two coil portions 6b can bias the holding portion 2 and the plate-like portion 3 in a balanced and stable manner, for example, in the width direction, even when the torsion spring 6 moves together with the plate-like portion 3 in the length direction (up-down direction) as in the present disclosure. This is particularly effective in the case where the torsion spring climbs over the raised portion 25 together with the plate-like portion 3 as in the present disclosure.

In contrast to the embodiment described above, the torsion spring 6 may alternatively be configured such that the one folded portion 6a biases the plate-like portion 3 and the two arm portions 6c bias the holding portion 2.

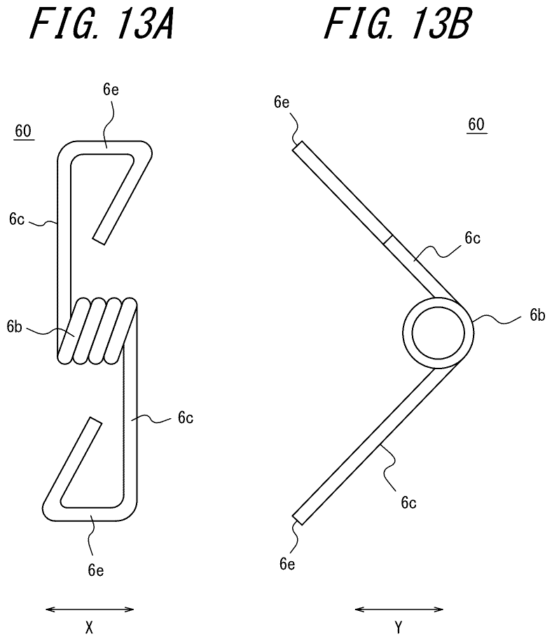

FIGS. 13A and 13B schematically illustrate another exemplary torsion spring 60 that can be used in the work equipment holder according to the present disclosure. FIG. 13A is a front view of the torsion spring 60, and FIG. 13B is a side view of the torsion spring 60.

The torsion spring 60 is a single torsion spring including one coil portion 6b. The torsion spring 60 includes one coil portion 6b and two arm portions 6c. The torsion spring 60 is obtained by integrally forming the one coil portion 6b and the two arm portions 6c using a single wire material. In the present disclosure, one of the two arm portions 6c biases one of the holding portion 2 and the plate-like portion 3, and the other of the two arm portions 6c biases the other of the holding portion 2 and the plate-like portion 3.

The elastic member attached to the connecting pin 4 is not limited to a torsion spring. Examples of the elastic member include a leaf spring and a rubber plate.

In the present disclosure, the push-in portion 31a in the operation portion 31 of the plate-like portion 3 is formed with the groove 31n and the protrusion 31d, as illustrated for example in FIG. 2. This allows the user to insert their finger into the groove 31n and hook it onto the protrusion 31d, thereby easily pulling the operation portion 31 toward the operation portion side (one side in the length direction). The push-in portion 31a may be provided with at least one of the groove 31n and the projection 31d. The groove 31n and the projection 31d may be formed by embossing or the like. The groove 31n and the projection 31d may be omitted.

In the present disclosure, the plate-like portion 3 includes the operation portion-side end part 3a extending toward the holding portion 2, and the depression 35 is formed at the holding portion-side end of the operation portion-side end part 3a, as illustrated for example in FIG. 5. In this case, the user's finger can be prevented from coming into contact with the holding portion-side end of the operation portion-side end part 3a when using the holder 1A. This improves the operability of the holder 1A as a work equipment holder.

In the present disclosure, the bent recess 3n is formed between the operation portion 31 and the pressing portion 32 of the plate-like portion 3, as illustrated for example in FIG. 6. This improves the strength of the plate-like portion 3, thereby reinforcing the plate-like portion 3 without adding any other component to the plate-like portion 3.

In the present disclosure, the swing restriction portion 7 is an arch portion bridged across the rear side of the holding portion 2, as illustrated for example in FIG. 6. In this case, if the plate-like portion 3 accidentally tries to move in the front-rear direction or the left-right direction, the pressing portion-side end part 3b of the plate-like portion 3 comes into contact with the holding portion 2 or the swing restriction portion 7. This prevents the plate-like portion 3 from coming off the swing restriction portion 7.

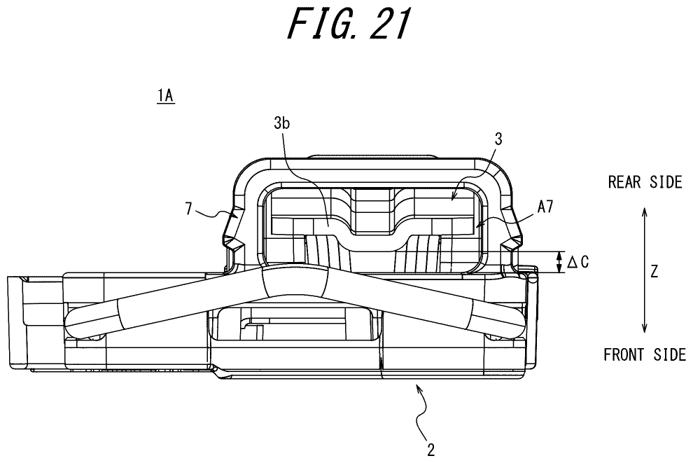

FIG. 21 is a bottom view schematically illustrating a modification of the holder 1A. In FIG. 21, the pressing portion-side end part 3b of the plate-like portion 3 is accommodated in the accommodation hole A7 of the swing restriction portion 7 provided on the holding portion 2 in a state of being separated from the holding portion 2.

In FIG. 21, in a state in which the plate-like portion 3 is moved along the long hole 5 to its limit on the pressing portion side, the pressing portion-side end part 3b of the plate-like portion 3 forms a clearance ΔC in the front-rear direction with the holding portion 2 in the accommodation hole A7 formed in the swing restriction portion 7, without contacting the holding portion 2. In this case, the gap S1 formed between the pressing portion 32 of the plate-like portion 3 and the holding portion 2 has an approximately rectangular contour as illustrated in FIG. 20, as in the case where the plate-like portion 3 includes the inclined portion 33. Therefore, in this case, too, for example if the work equipment is a tool holder, the tool holder is less likely to incline relative to the belt B, making it easier to put tools in and take them out.

Means for forming the clearance ΔC include, for example, the inclined portion 33 provided on the plate-like portion 3, adjusting the opening angle or spring constant of the torsion spring (elastic member), or placing a spacer between the holding portion 2 and the plate-like portion 3.

In the present disclosure, the pressing portion-side end part 3b of the plate-like portion 3 is accommodated inside the accommodation hole A7 formed in the swing restriction portion 7. Alternatively, in a state in which the plate-like portion 3 is moved to the pressing portion side, the pressing portion-side end part 3b of the plate-like portion 3 may pass through the accommodation hole A7 formed in the swing restriction portion 7 to be exposed from the swing restriction portion 7.

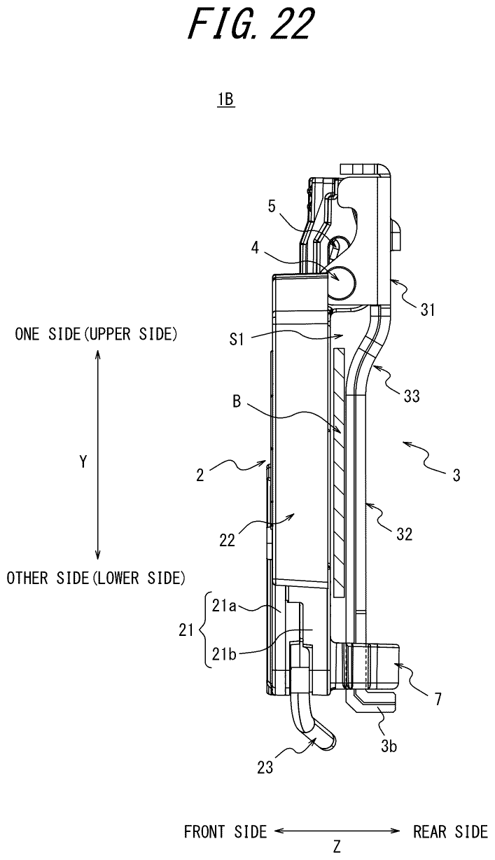

FIG. 22 schematically illustrates a state in which a holder 1B according to Embodiment 2 of the present disclosure is attached to a belt B. Detailed description of components that are substantially the same as those of the holder 1A will be omitted.

In the holder 1B, when the plate-like portion 3 is moved to the pressing portion side (other side in the length direction) relative to the holding portion 2, the pressing portion-side end part 3b of the plate-like portion 3 passes through the accommodation hole A7 formed in the swing restriction portion 7 and is exposed from the swing restriction portion 7. In addition, the pressing portion-side end part 3b of the plate-like portion 3 is curved rearward. Thus, moving the plate-like portion 3 to the pressing portion side (lower side) relative to the holding portion 2 can cause the pressing portion-side end part 3b of the plate-like portion 3 to pass through the accommodation hole A7 formed in the swing restriction portion 7 and consequently be hooked onto the swing restriction portion 7, as illustrated in FIG. 22. Specifically, by utilizing the flexibility of the plate-like portion 3, the pressing portion-side end part 3b of the plate-like portion 3 can be passed through the accommodation hole A7 formed in the swing restriction portion 7 and hooked onto the end on the other side (lower end) in the length direction of the swing restriction portion 7. This prevents the plate-like portion 3 from moving to the operation portion side (upper side) relative to the swing restriction portion 7. Therefore, the holder 1B can be later-attached to the belt B as with the holder 1A, and also can be prevented from coming off the swing restriction portion 7.

The pressing portion-side end part 3b of the plate-like portion 3 illustrated in FIG. 22 may be a return portion that is bent back toward the operation portion-side end part 2a of the holding portion 2. In view of the ease of detachment from the swing restriction portion 7, however, it is preferable that the pressing portion-side end part 3b of the plate-like portion 3 is curved rearward so as to be hooked only on the end on the other side (lower end) in the length direction of the swing restriction portion 7 as in this embodiment. Alternatively, the pressing portion-side end part 3b of the plate-like portion 3 may be bent frontward toward the holding portion 2 so as to easily fit into the accommodation hole A7 formed in the swing restriction portion 7.

The swing restriction portion 7 may be a return portion that is bent back on the rear side of the holding portion 2 from the pressing portion-side end part 2b of the holding portion 2 toward the operation portion-side end part 2a of the holding portion 2.

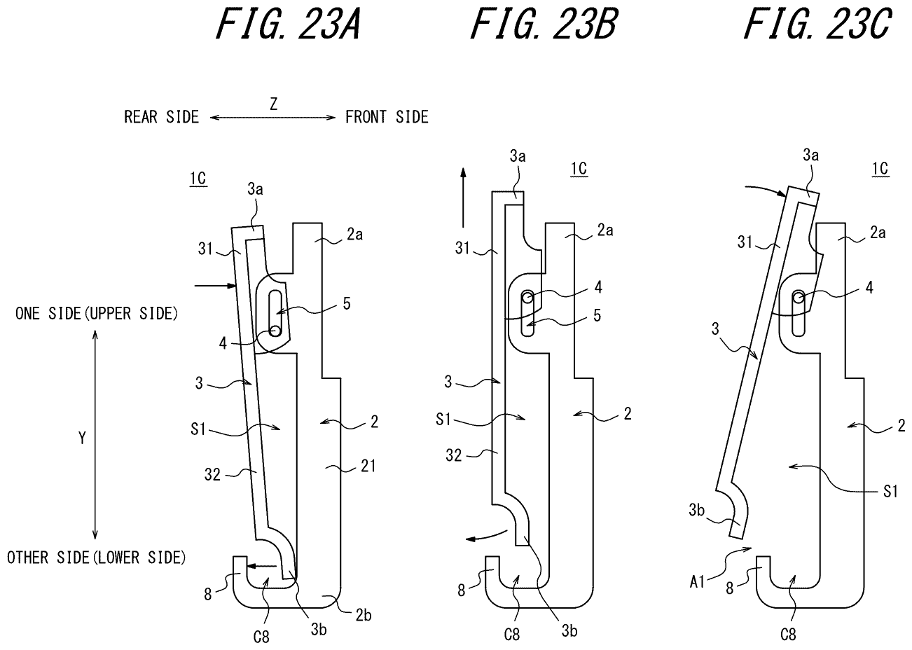

FIGS. 23A to 23C are each a right side view schematically illustrating a holder 1C according to Embodiment 3 of the present disclosure. FIG. 23A schematically illustrates the holder 1C in a state in which the pressing portion-side end part 3b of the plate-like portion is accommodated in an accommodation recess C8 formed in the swing restriction portion 8. FIG. 23B schematically illustrates the holder 1C in FIG. 23A in a state in which the pressing portion-side end part 3b of the plate-like portion is withdrawn from the accommodation recess C8 of the swing restriction portion 8 as a result of the plate-like portion 3 being moved to the operation portion side relative to the holding portion 2. FIG. 23C schematically illustrates the holder 1C in FIG. 23B in a state in which the pressing portion-side end part 3b of the plate-like portion 3 is opened relative to the holding portion 2.

An example of a method of using the holder 1C will be described below.

With reference to FIG. 23A, when the plate-like portion 3 is located on the pressing portion side (upper side) relative to the holding portion 2, the pressing portion-side end part 3b of the plate-like portion 3 is accommodated in the accommodation recess C8 formed in the swing restriction portion 8. During this, the pressing portion-side end part 3b of the plate-like portion 3 is in contact with the holding portion 2 due to the biasing force of the arm portions 6c of the torsion spring 6. Accordingly, as illustrated in FIG. 23A, the pressing portion-side end part 3b of the plate-like portion 3 is in contact with the holding portion 2 and is accommodated in the accommodation recess C8 of the swing restriction portion 8.

In the present disclosure, the swing restriction portion 8 is a return portion th is bent back on the rear side of the holding portion 2 from the pressing portion-side end part 2b of the holding portion 2 toward the operation portion-side end part 2a of the holding portion 2. The accommodation recess C8 that is open on the operation portion side (one side in the length direction) is formed in the swing restriction portion 8.

Next, an example of a method of using the holder 1C will be described. In the following description, the long hole 5 is assumed to be a straight, I-shaped long hole without a relief hole 5d. The other parts are substantially the same as those of the holder 1A, and detailed description of structures such as the torsion spring 6 and the raised portion 25 will be omitted.

In the holder 1C, to withdraw the pressing portion-side end part 3b of the plate-like portion 3 from the accommodation recess C8 formed in the swing restriction portion 8, while pushing the operation portion 31 of the plate-like portion 3 toward the holding portion 2, the operation portion 31 is pulled toward the operation portion side (one side in the length direction). As a result, the plate-like portion 3 moves together with the connecting pin 4 along the long hole 5 to the operation portion side (one side in the length direction), as illustrated in FIG. 23B. The pressing portion-side end part 3b of the plate-like portion 3 can thus be withdrawn from the accommodation recess C8 of the swing restriction portion 8, as illustrated in FIG. 23B.

To open the pressing portion 32 of the plate-like portion 3, after the plate-like portion 3 has been moved together with the connecting pin 4 along the long hole 5 to its limit on the operation portion side (one side in the length direction), the operation portion 31 of the plate-like portion 3 is further pushed toward the holding portion 2 against the biasing force of the torsion spring 6. As a result, the pressing portion-side end part 3b of the plate-like portion 3 can be opened relative to the holding portion 2 about the connecting pin 4 as a pivot, as illustrated in FIG. 23C.

The above series of operations on the holder 1C can be performed, for example, by holding the holder 1C in one hand and using the thumb of the same hand.

When attaching the holder 1C to the belt B, for example, the belt B is passed through the gap S1 formed between the plate-like portion 3 and the holding portion 2 or the holder 1C is hooked onto the belt B from above, and then the push on the operation portion 31 of the plate-like portion 3 is released.

Specifically, in a state in which the pressing portion-side end part 3b of the plate-like portion 3 is opened as a result of pushing the operation portion 31 of the plate-like portion 3, the holder 1C is moved downward from above the belt B to pass the belt B through the opening A1 formed between the holding portion 2 and the pressing portion-side end part 3b of the plate-like portion 3 and accommodate it in the gap S1. The push on the operation portion 31 of the plate-like portion 3 is then released, as a result of which the pressing portion-side end part 3b of the plate-like portion 3 automatically closes so as to contact the holding portion 2 under the biasing force of the torsion spring 6, as illustrated in FIG. 23B. Subsequently, when the operation portion 31 of the plate-like portion 3 is pushed toward the pressing portion side (other side in the length direction), the plate-like portion 3 moves to the pressing portion side (other side in the length direction) relative to the holding portion 2. As a result, the pressing portion-side end part 3b of the plate-like portion 3 is accommodated in the accommodation recess C8 of the swing restriction portion 8 while the belt B remains accommodated in the gap S1, as illustrated in FIG. 23A.

If the plate-like portion 3 swings in a direction that opens the pressing portion-side end part 3b about the connecting pin 4 as a pivot, the pressing portion-side end part 3b of the plate-like portion 3 contacts the holding portion 2 or the swing restriction portion 8, as illustrated for example in FIG. 23A. Accordingly, the holder 1C is kept from falling off the belt B by accommodating the pressing portion-side end part 3b of the plate-like portion 3 in the accommodation recess A8 of the swing restriction portion 8.

As described above, the holder 1C can be later-attached to the belt B as with the holder 1A, and also can be prevented from coming off the swing restriction portion 7 as with the holder 1B.

Moreover, the holder 1C can be easily removed from the belt B. When the plate-like portion 3 is pulled upward in a state in which the holder 1C is attached to the belt B, the pressing portion-side end part 3b of the plate-like portion 3 is withdrawn from the accommodation recess C8 of the swing restriction portion 8 as illustrated for example in FIG. 23B. This allows the pressing portion-side end part 3b of the plate-like portion 3 to freely open about the connecting pin 4 as a pivot. Hence, further pushing the operation portion 31 of the plate-like portion 3 toward the holding portion 2 against the biasing force of the torsion spring 6 can open the pressing portion-side end part 3b of the plate-like portion 3 about the connecting pin 4 as a pivot, as illustrated in FIG. 23C. By lifting the holder 1C upward with the pressing portion-side end part 3b of the plate-like portion 3 open, the holder 1C can be easily removed from the belt B.

Then, when the push on the operation portion 31 of the plate-like portion 3 is released, the pressing portion-side end part 3b of the plate-like portion 3 automatically closes under the biasing force of the torsion spring 6. After this, moving the plate-like portion 3 to the pressing portion side (other side in the length direction) restores the initial state illustrated in FIG. 23A. Thus, the holder 1C can be easily removed from the belt B, as with the holder 1A.

While exemplary embodiments of the present disclosure have been described above, various changes can be made within the scope of the claims. For example, a non-slip protrusion 28 is formed on the front side of the operation portion-side end part 2a of the holding portion 2, as illustrated in FIG. 1. This improves the operability of the holder as a work equipment holder. However, the protrusion 28 may be omitted. Additionally, in the above embodiments, the methods of attaching the holders 1A to 1C to the belt B have been described with the holders 1A to 1C used or operated in an upright position, for ease of explanation. However, the holders 1A to 1C are not limited to being used or operated in an upright position. Furthermore, various structural features adopted in the above embodiments may be used in combination with one another.

### REFERENCE SIGNS LIST

1A work equipment holder (Embodiment 1)
1B work equipment holder (Embodiment 2)
1C work equipment holder (Embodiment 3)
2 holding portion
2a operation portion-side end part of holding portion
2b pressing portion-side end part of holding portion
2d notch portion
2g guide groove
2s holding position
21 main body portion
21a base plate
21b sub-plate
22 stopper member
23 safety rope attachment portion
23S rope insertion opening
24 mount portion
25 raised portion
25a operation portion-side inclined surface of raised portion
25b pressing portion-side inclined surface of raised portion
25c top part of raised portion
26 operation portion-side end wall of holding portion
27 slit
3 plate-like portion
3a operation portion-side end part of plate-like portion
3b pressing portion-side end part of plate-like portion
3n bent recess
31 operation portion of plate-like portion
31a push-in portion of operation portion
31b side wall of operation portion
31d protrusion
31n groove
32 pressing portion of plate-like portion
33 inclined portion of plate-like portion
34 stopper
35 depression
4 connecting pin
4a shaft of connecting pin
4b flange of connecting pin
5 long hole
5a operation portion-side end part of long hole
5b pressing portion-side end part of long hole
5c intermediate part of long hole
5d relief hole of long hole
6 torsion spring (double torsion spring)
6a folded portion
6b coil portion
6c arm portion
6e tip part of arm portion
60 torsion spring (single torsion spring)
7 swing restriction portion
8 swing restriction portion
100 work equipment
110 bracket provided on the work equipment
A1 opening formed between holding portion and pressing portion-side end part of plate-like portion
A3 through-hole formed in push-in portion of operation portion
A7 accommodation hole formed in swing restriction portion
B belt
C8 accommodation recess
L1 length direction centerline of long hole
L2 width direction centerline of long hole
S1 gap formed between holding portion and pressing portion of plate-like portion

1. A work equipment holder configured to attach work equipment to a belt, the work equipment holder comprising:
a holding portion configured to hold the work equipment on a front side;
a plate-like portion disposed on a rear side of the holding portion;
a connecting pin swingably connecting the holding portion and the plate-like portion; and
an elastic member attached to the connecting pin,
wherein the elastic member is configured to bias an operation portion of the plate-like portion in a direction away from the holding portion, to bias a pressing portion of the plate-like portion in a direction approaching the holding portion with the connecting pin as a pivot,
a long hole through which the connecting pin slidably passes is formed in the holding portion or the plate-like portion, and
a swing restriction portion is provided on the rear side of the holding portion, the swing restriction portion being configured to restrict swinging of the plate-like portion in a state in which the plate-like portion is moved along the long hole to a pressing portion side of the plate-like portion, and allow swinging of the plate-like portion in a state in which the plate-like portion is moved along the long hole to an operation portion side of the plate-like portion.

2. The work equipment holder according to claim 1, wherein the plate-like portion includes a stopper configured to, when the plate-like portion is moved along the long hole to the pressing portion side of the plate-like portion in a state in which the operation portion of the plate-like portion is pushed toward the holding portion, contact the holding portion before a pressing portion-side end part of the plate-like portion reaches the swing restriction portion, thereby preventing the plate-like portion from moving along the long hole to the pressing portion side of the plate-like portion.

3. The work equipment holder according to claim 1, wherein a relief hole extending in a direction away from the holding portion is connected to a pressing portion-side end part of the long hole.
